(19) United States
(12) Patent Application Publication
(10) Pub. No.: US 2026/0099149 A1
(43) Pub. Date: Apr. 9, 2026

(54) CONTROL OF DYNAMICALLY STABLE ROBOT BASED ON FAULT-STATE FALL PROPERTY AND RELATED TECHNOLOGY

(71) Applicant: Agility Robotics, Inc., Pittsburgh, PA (US)

(72) Inventors: Andrew Abate, Albany, OR (US); Tianyao Chen, Pittsburgh, PA (US); Jay Jasper, Albany, OR (US); Ezm Masoud, Kitchener (CA); Kevin Reese, Johannesburg, MI (US); Brian Kirby, Pittsburgh, PA (US); Melonee Wise, San Jose, CA (US); Prasanna Velagapudi, Pittsburgh, PA (US); Ryan Domres, Albany, OR (US)

(21) Appl. No.: 19/352,114

(22) Filed: Oct. 7, 2025

Related U.S. Application Data
(60) Provisional application No. 63/705,465, filed on Oct. 9, 2024.
(60) Provisional application No. 63/720,334, filed on Nov. 14, 2024.
(60) Provisional application No. 63/784,437, filed on Apr. 7, 2025.
(60) Provisional application No. 63/883,846, filed on Sep. 18, 2025.

(51) Int. Cl. G05D 1/49; B62D 57/032; G05D 1/617; G05D 109/12

(52) U.S. Cl. CPC G05D 1/49; B62D 57/032; G05D 1/617; G05D 2109/12

(57) ABSTRACT

A method in accordance with at least some embodiments of the present technology includes generating a first motion command for changing a pose of a mobile robot. This occurs via a computer system operably associated with the mobile robot. The method further includes determining an indication of a fault-state fall property of the mobile robot corresponding to the first motion command. The indication is based at least partially on joint-encoder data and inclinometer data from the mobile robot. The method still further includes generating a second motion command for changing the pose of the mobile robot based at least partially on the indication. The method also includes executing movement of the mobile robot corresponding to the second motion command. Executing this movement occurs via an actuator of the mobile robot and causes the fault-state fall property to move toward a target range.

### CROSS-REFERENCE TO RELATED APPLICATION

This claims the benefit of U.S. Provisional Application No. 63/705,465 filed Oct. 9, 2024, U.S. Provisional Application No. 63/720,334 filed Nov. 14, 2024, U.S. Provisional Application No. 63/784,437 filed Apr. 7, 2025, and U.S. Provisional Application No. 63/883,846 filed Sep. 18, 2025. The foregoing applications are incorporated herein by reference in their entirety. To the extent the foregoing applications or any other material incorporated by reference conflicts with the present disclosure, the present disclosure controls.

### TECHNICAL FIELD

The present technology relates to control of dynamically stable robots.

### BACKGROUND

Much of the work that humans currently perform is amenable to automation using robotics. For example, many human workers currently focus on executing predefined movements of items and containers at order-fulfillment centers. Such predefined movements may occur millions of times a day at a single order-fulfillment center and billions of times a day across a network of order-fulfillment centers. Human effort is better suited to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous features may be omitted when the appropriate reference-number labels for such analogous features are clear in the context of the specification and all of the drawings considered together. Furthermore, the same reference numbers may be used to identify analogous features in multiple described embodiments.

FIG. 1 is a perspective view of a mobile robot in accordance with at least some embodiments of the present technology.

FIG. 2 is a block diagram corresponding to a method of controlling a mobile robot in accordance with at least some embodiments of the present technology.

FIG. 3 is a block diagram depicting an environment relevant to the method of FIG. 2.

FIG. 4 is a block diagram illustrating an example of movement of information during an example of the method of FIG. 2.

FIG. 5 is a perspective view of the mobile robot of FIG. 1 at a time during an example of the method of FIG. 2.

FIG. 6 is a top plan view of foot-pose derivatives relevant to the method of FIG. 2 at the time shown in FIG. 5.

FIG. 7 is a perspective view of the mobile robot of FIG. 1 at another time during an example of the method of FIG. 2.

FIGS. 8 and 9 are top plan views of foot-pose derivatives relevant to the method of FIG. 2 at the time shown in FIG. 7.

FIG. 10 is a block diagram corresponding to another method of controlling a mobile robot in accordance with at least some embodiments of the present technology.

FIG. 11 is a top plan view of the mobile robot of FIG. 1 and a representation of an arm-extension rule relevant to the method of FIG. 10.

FIG. 12 is a partial perspective view of another mobile robot in accordance with at least some embodiments of the present technology.

FIG. 13 is a top plan view of the mobile robot of FIG. 12 and a representation of visual projections during an example of the method of FIG. 10.

FIGS. 14-18 are block diagrams corresponding to additional respective methods of controlling a mobile robot in accordance with at least some embodiments of the present technology.

FIGS. 19-21 are block diagrams corresponding to different respective configurations of mobile robots in accordance with at least some embodiments of the present technology.

FIG. 22 is a block diagram corresponding to an actuator of a mobile robot in accordance with at least some embodiments of the present technology.

FIG. 23 is a block diagram depicting a system including electrical, computer, and software components operably associated with a mobile robot in accordance with at least some embodiments of the present technology.

FIG. 24 is a block diagram depicting software architecture and associated portions of the system of FIG. 23.

### DETAILED DESCRIPTION

Disclosed herein are methods, devices, and systems related to controlling dynamically stable robots. Dynamically stable robots rely on active control to maintain stability during normal operation. In contrast, statically stable robots operate in an inherently stable state. As an example, many conventional autonomous mobile robots (AMRs) currently used for warehouse logistics have four wheels and are statically stable. No active control is needed to maintain the stability of these robots during normal operation. If a statically stable AMR loses power or otherwise becomes disabled, it remains in a stable, stationary state rather than collapsing unpredictably. As another example, bipedal robots are dynamically stable in most, if not all cases. Such robots are always falling to some degree during normal operation. Dynamically stable robots maintain effective stability by monitoring state-related variables and making rapid pose adjustments to counteract destabilizing forces as needed. If a dynamically stable robot loses power or otherwise becomes disabled, it collapses. As yet another example, a quadrupedal robot may move between dynamically stable operation (e.g., while running) and statically stable operation (e.g., while walking or standing). Operating a robot in a dynamically stable state permanently or temporarily can be useful to increase speed, maneuverability, and range of motion, among other potential benefits. Indeed, a dynamically stable robot with a relatively compact footprint is typically able to execute a much wider range of behaviors than a statically stable robot with a similar footprint.

Operating a robot in a dynamically stable state also presents certain challenges. Perhaps most significant among these challenges are those related to hazard mitigation in collaborative environments. Robots, like other types of machinery, have the potential to harm humans. Historically, an approach to reducing the risk of a machine harming a human has been to ensure that the machine has features that allow a human to disable the machine quickly and intuitively. For example, a material feeder of an industrial machine is likely to have a highly accessible button that allows an operator to deactivate the material feeder immediately if needed. If a hazardous situation arises (e.g., the material feeder snags the operator's clothing), the operator can press the button to cause the material feeder to stop moving. Once the material feeder stops moving, the operator can remedy the hazardous situation (e.g., free the snagged clothing) and avoid serious injury. In this example, the hazard-mitigation potential of the disabling button is obvious. Because of cases like this, modern regulations and standards related to workplace safety require that potentially hazardous machinery operated near humans include accessible and intuitive disabling features. Moreover, machine disabling may be required to occur automatically in some cases. Unfortunately, disabling a dynamically stable robot is not as straightforward as disabling a simple material feeder. As discussed above, dynamically stable robots collapse in the absence of active control. As a further challenge, dynamically stable robots may fall and/or collapse in other circumstances, such as in response to connectivity interruptions, slips, and strong impacts. These and certain other potential movements of dynamically stable robots may occur quickly and unpredictably. Accordingly, close encounters between humans and dynamically stable robots are potentially hazardous. Ironically, this includes close encounters associated with accessing and activating a disabling feature on such a robot.

One strategy for hazard mitigation in the context of dynamically stable robots involves segregation. For example, dynamically stable robots can be confined to enclosed workcells that humans cannot access. This approach, however, greatly reduces the productive potential of dynamically stable robots. For example, the tasks that dynamically stable robots facilitate often involve direct interaction with humans. Furthermore, even when humans and dynamically stable robots perform different tasks, it is highly desirable in most cases for the humans and the dynamically stable robots to share certain spaces, such as aisles and walkways. Another strategy for hazard mitigation in the context of dynamically stable robots involves detection. A dynamically stable robot can transition to a statically stable state when it detects that a human is nearby. This strategy is potentially useful, but has several drawbacks and limitations. First, transitioning a dynamically stable robot to a statically stable state, even if fully autonomous, can unduly interfere with efficiency and workflow execution, especially in crowded environments. Second, current detection technologies are fallible. For example, even the most sophisticated detection technologies would be unlikely to detect a close encounter between a human and a dynamically stable robot at a blind corner. In the context of safety, even a small possibility of failure may be unacceptable. Finally, the process of detecting a human and the process of transitioning a dynamically stable robot to a statically stable state both take time. This time can cause the threshold human-to-robot distance for triggering the transition to be impractically large, especially in scenarios in which the human and the dynamically stable robot are moving toward one another.

Methods, devices, and systems in accordance with at least some embodiments of the present technology include innovation that promotes one or more useful objectives in the field of collaborative robotics. Such objectives may include facilitating the safe operation of dynamically stable robots in the presence of humans. In an example, a method in accordance with at least some embodiments of the present technology includes controlling a mobile robot based at least partially on a fault-state fall property of the mobile robot representing some aspect of how the mobile robot would behave at any given time if it were to suddenly enter into a fault state and lose dynamic stability. The fault-state fall property may include directional characteristics (e.g., whether the robot would fall forward, backward, or to either side) and/or extent characteristics (e.g., how far the robot's components would extend during a fall). In a more specific example, a safety controller of a computer system operably associated with a mobile robot can compare a center-of-mass property of the mobile robot and a condition to determine a fault-state fall property in real time or in near real time. The safety controller can then override, reverse, or otherwise change a movement command from a motion controller of the computer system to prevent the fault-state fall property from deviating from an acceptable range. This proactive approach to safety can allow the robot to maintain safe operational parameters even before a fault occurs. As another example, a method in accordance with at least some embodiments of the present technology includes sensing a human in an environment and changing a fault-state behavior of one or more actuators to cause a fault-state fall direction to be away from the human.

A control strategy based on one or more fault-state fall properties of a mobile robot in accordance with at least some embodiments of the present technology can limit a zone around the mobile robot where contact with a human is possible during a fault event. This can allow for predictable safety boundaries that can be communicated to human collaborators and integrated into workspace safety protocols. In at least some cases, such a control strategy is reliable enough that the presence of a human in other portions of the zone is safe within practical limits. Furthermore, a control strategy based on one or more fault-state fall properties of a mobile robot in accordance with at least some embodiments of the present technology can be associated with one of two or more different control regimes. These control regimes may represent different operational modes with varying trade-offs between performance capabilities and safety constraints. In another of the control regimes, control of the mobile robot may be relatively independent of the applicable fault-state fall property or properties, allowing for greater operational freedom when appropriate. In these and other cases, the mobile robot may change from one control regime to another control regime in different circumstances, such as when transitioning between collaborative and non-collaborative work areas, or when changing task requirements necessitate different safety-performance balances. Furthermore, this change may occur after a warning period during which any humans in the vicinity of the mobile robot have sufficient time to prepare for the change.

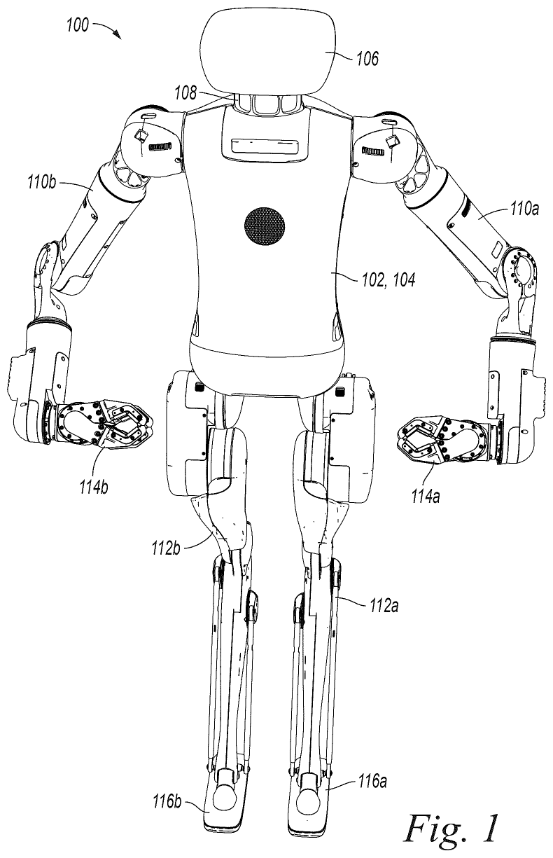

The foregoing and many other features of methods, devices, and systems in accordance with various embodiments of the present technology are further described below with reference to FIGS. 1-24. Although methods, devices, and systems may be described herein primarily or entirely in the context of bimanual, bipedal robots, other contexts are within the scope of the present technology. For example, suitable features of described methods, devices, and systems can be implemented in the context of mobile robots with one arm, in the context of mobile robots with more than two arms, and/or in the context of non-legged mobile robots such as wheeled platforms, tracked vehicles, or hybrid locomotion systems. The principles of fault-state fall property control can be adapted to these various robot morphologies by accounting for their specific kinematic structures, stability characteristics, and operational requirements. Accordingly, the word “bipedal” as used herein may be replaced with “mobile” to encompass non-bipedal counterparts within the present technology unless the context clearly indicates otherwise. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Mobile Robots

FIG. 1 is a perspective view of a mobile robot 100 relevant to methods in accordance with at least some embodiments of the present technology. As shown in FIG. 1, the mobile robot 100 can be humanoid in form. It can include structures resembling human anatomy with respect to the features, positions, and/or other characteristics of such structures, including articulated limbs, a torso, and a head positioned in anatomically human-like arrangements. In at least some cases, the mobile robot 100 defines a midsagittal plane (not shown) about which it is bilaterally symmetrical. In these and other cases, the mobile robot 100 can be configured for mobile locomotion similar to that of a human. Counterparts of the mobile robot 100 can have other suitable features. For example, a counterpart of the mobile robot 100 can have a non-humanoid form, such as a canine form, an insectoid form, an arachnoid form, or a form with no animal analog. Furthermore, a counterpart of the mobile robot 100 can be asymmetrical or have symmetry other than bilateral, such as radial symmetry or intentionally asymmetric designs optimized for specific functional requirements. Still further, a counterpart of the mobile robot 100 can be configured for non-bipedal locomotion. For example, a counterpart of the mobile robot 100 can be configured for another type of legged locomotion (e.g., quadrupedal locomotion, hexapedal locomotion, octopedal locomotion, etc.) or non-legged locomotion (e.g., wheeled locomotion using two or more wheels, continuous-track locomotion similar to tank treads, etc.). The principles of fault-state fall property control described herein can be adapted to any of these robot morphologies with appropriate modifications to account for their specific stability characteristics.

With reference again to FIG. 1, the mobile robot 100 can include a centrally disposed body 102 through which other structures are interconnected. As all or a portion of the body 102, the mobile robot 100 can include a torso 104. The mobile robot 100 can further include a head 106 superiorly spaced apart from the torso 104. The mobile robot 100 can also include a neck 108 through which the head 106 is connected to the torso 104 via a superior portion of the torso 104. The mobile robot 100 can further include articulated appendages carried by the torso 104. Among these articulated appendages, the mobile robot 100 can include arms 110 (individually identified as arms 110a, 110b) and legs 112 (individually identified as legs 112a, 112b). At individual articulations of the arms 110a, 110b and legs 112a, 112b, the mobile robot 100 can include a joint and a corresponding actuator, such as a rotary actuator with a motor and gearing (e.g., cycloidal gearing or strain-wave gearing). Rather than being positioned at a joint, some actuators of the mobile robot 100 may be operably associated with a joint via a connecting structure, such as a connecting rod. For clarity of illustration, the joints, actuators, and connecting structures of the mobile robot 100 are not labeled in FIG. 1.

The mobile robot 100 can be configured to manipulate objects via the arms 110a, 110b, such as bimanually. The mobile robot 100 can be configured to ambulate via the legs 112a, 112b. The arms 110a, 110b and the legs 112a, 112b can separately extend distally from the body 102 and define respective kinematic chains. The individual kinematic chains corresponding to the arms 110a, 110b can provide at least five degrees of freedom, such as exactly five or exactly six degrees of freedom. In these and other cases, the respective kinematic chains corresponding to the legs 112a, 112b can provide at least four degrees of freedom, such as exactly four, exactly five, or exactly six degrees of freedom. As parts of the arms 110a, 110b and at distalmost portions of the corresponding kinematic chains, the mobile robot 100 can include end effectors 114a, 114b. Similarly, as parts of the legs 112a, 112b and at distalmost portions of the corresponding kinematic chains, the mobile robot 100 can include feet 116a, 116b. Thus, the arms 110a, 110b and legs 112a, 112b can distally carry the end effectors 114a, 114b and the feet 116a, 116b, respectively.

As mentioned above, a counterpart of the mobile robot 100 can be a wheeled mobile robot including one or more wheels instead of or in addition to the feet 116a, 116b. The wheels can be configured to interact with a ground surface while the wheeled mobile robot is in motion. In an example, the wheeled mobile robot is the same as or similar to the mobile robot 100 superior to the feet 116a, 116b. Instead of the feet 116a, 116b, the wheeled mobile robot can include a wheeled base. The legs 112a, 112b can extend between the wheeled base and the body 102. In another example, a single counterpart of the legs 112a, 112b can extend between the wheeled base and the body 102. Like the mobile robot 100, the wheeled mobile robot can be dynamically stable in that it relies on active control to maintain stability during normal operation. This is typical, for example, when an overall footprint of the wheeled base on the ground surface is relatively small. The active control can be implemented at least partially by changing respective poses of links of the wheeled mobile robot superior to the wheeled base. Accordingly, use of a fault-state fall property in accordance with at least some embodiments of the present technology can be relevant to controlling the wheeled mobile robot. It should be understood, therefore, that the wheeled mobile robot can be substituted for the mobile robot 100 in descriptions herein of at least some embodiments of the present technology unless the context clearly indicates otherwise.

### Examples of Methods

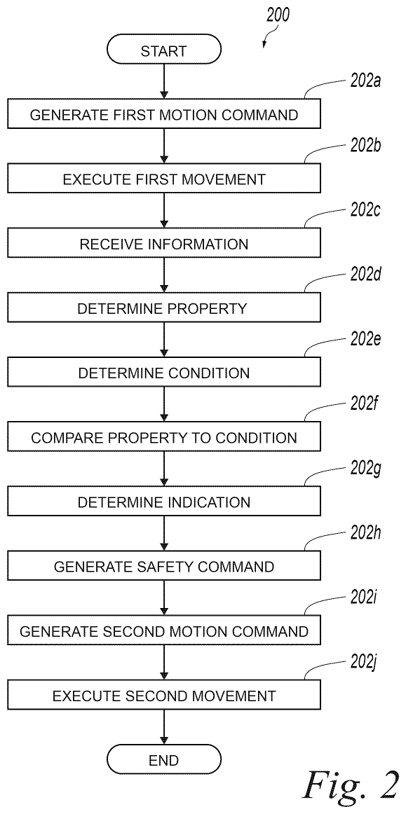

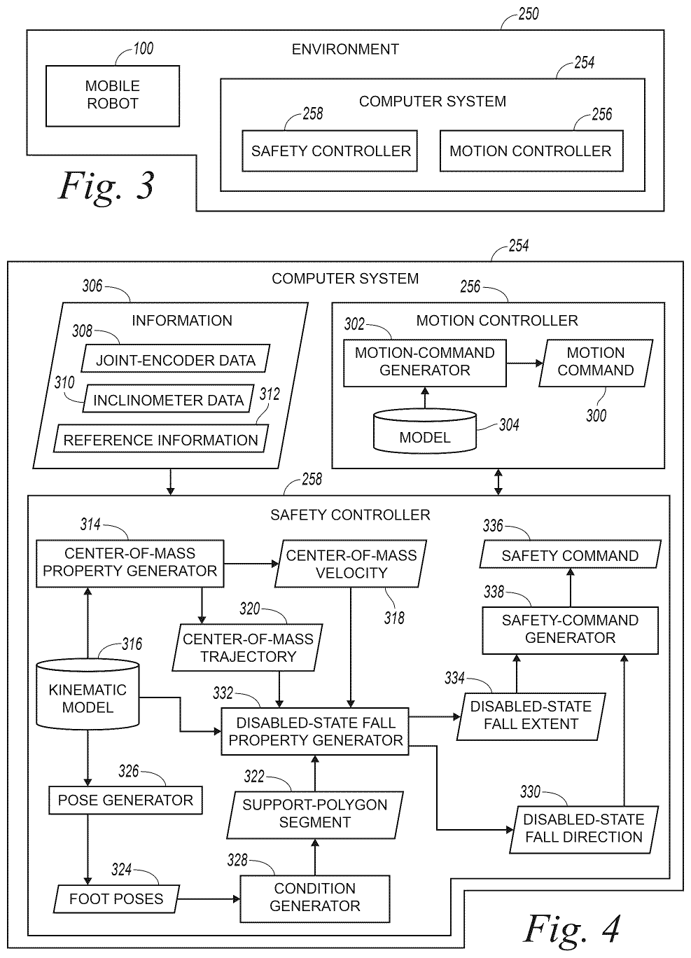

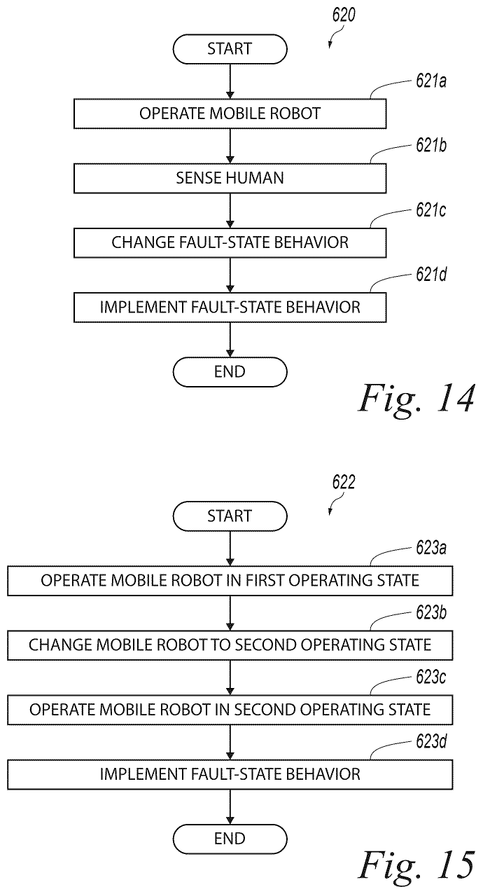

FIG. 2 is a block diagram corresponding to a method 200 of controlling the mobile robot 100 in accordance with at least some embodiments of the present technology. The diagram includes blocks 202a-202j corresponding to different respective portions of the method 200. FIG. 3 is a block diagram depicting an environment 250 relevant to the method 200. As shown in FIG. 3, the environment 250 can include the mobile robot 100 and a computer system 254 operably associated with one another. The computer system 254, in turn, can include a motion controller 256 and a safety controller 258 operably associated with one another. FIG. 4 is a block diagram illustrating an example of movement of information during an example of the method 200. FIG. 4 also shows selected components of the computer system 254 in the context of this movement of information. Further technical, implementation, and other details regarding various examples of the mobile robot 100 and the computer system 254 are provided below in the context of FIGS. 14 and 15.

With reference to FIGS. 1-4 together, the method 200 can include generating a motion command 300 for changing a pose of the mobile robot 100 (block 202a). This can occur via the computer system 254 at the motion controller 256 during normal operation of the mobile robot 100. For example, the motion controller 256 can include a motion command generator 302 that generates the motion command 300 pursuant to a plan, behavior, and/or other higher-level aspect of a control strategy for the mobile robot 100. In at least some cases, the motion command 300 includes subcommands for different respective actuators of the mobile robot 100. For example, the computer system 254 can interpret a target pose for the mobile robot 100 via a model 304, determine joint angles corresponding to the target pose via an inverse-kinematic solver, and convert the joint angles into specific subcommands (e.g., motor torques, velocities, etc.) via suitable control algorithms for the actuators. In at least some cases, the model 304 is a machine-learning model generated by a machine-learning algorithm (e.g., a reinforcement-learning algorithm) trained on real and/or simulated contextual information.

The method 200 can further include executing movement of the mobile robot 100 corresponding to the motion command 300 (block 202b). This can occur via one or more of the actuators. The method 200 can also include receiving information 306 corresponding to the movement at the safety controller 258 (block 202c). The information 306 can include joint-encoder data 308 from joint encoders of the mobile robot 100 operably associated with the actuators. In addition or alternatively, the information 306 can include inclinometer data 310 from an inclinometer of the mobile robot 100. The information 306 can also include reference information 312, such as a past position and orientation of the mobile robot 100 (e.g., from a known docking pose of the mobile robot 100), a position and orientation of a fiducial (e.g., an AprilTag) detectable by a vision sensor of the mobile robot 100, a ground-plane position from ground contact detectable by the mobile robot 100, and/or other information relevant to determining a current position and orientation the mobile robot 100. Instances of the information 306 can be received at the safety controller 258 for use in monitoring and/or controlling one or more fault-state fall properties of the mobile robot 100.

A fault-state fall property of the mobile robot 100 in an example of the method 200 is a property that results from a fault in which the mobile robot 100 transitions from a non-fault state (e.g., a regular state, a working state, an uninterrupted state, a functional state, a non-disabled state, etc.) to a fault state (e.g., an irregular state, a non-working state, an interrupted state, a non-functional state, a disabled state, etc.). In practice, the transition can occur by default or in response to a command. Furthermore, the transition can occur in conjunction with a fault event, such as loss of power to the mobile robot 100, loss of connectivity with the mobile robot 100, and/or breach of a boundary around the mobile robot 100. Still further, the fault-state fall property may manifest immediately following a fault event or after a delay. Two examples of relevant fault-state fall properties are fault-state fall direction and fault-state fall extent.

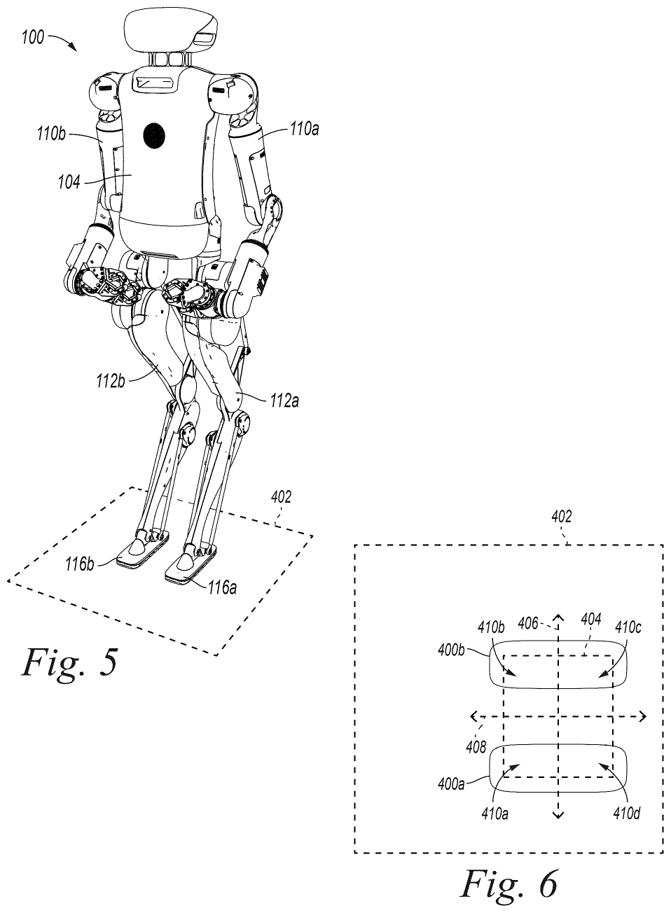

Fault-state fall direction can be a direction in which the mobile robot 100 falls upon and/or shortly after a fault event. This can be defined in a plane parallel to a ground plane under the mobile robot 100 and further defined relative to a vertical reference line that approximates a center of the mobile robot 100. In practice, the fault-state fall direction may manifest relatively quickly (e.g., immediately, in less than one second, etc.) following a fault event. Furthermore, the fault-state fall direction can be a function of the information 306 and a kinematic model 316 that represents kinematic relationships between hardware components of the mobile robot 100. The kinematic model 316 can be the same as or different than the model 304. In at least some cases, the safety controller 258, using the kinematic model 316, is capable of determining a fault-state fall direction for any possible combination of the joint-encoder data 308, the inclinometer data 310, and the reference information 312. As discussed below with reference to FIGS. 5-9, the process of determining the fault-state fall direction can include defining and segmenting a stability polygon in a ground plane. In addition or alternatively, the process can include defining a fulcrum plane, which can be a function of the stability polygon.

Fault-state fall extent can be a maximum distance in which contact with the mobile robot 100 is possible upon and/or shortly after a fault event. As with fault-state fall direction, fault-state fall extent can be defined in a plane parallel to a ground plane under the mobile robot 100 and further defined relative to a vertical reference line that approximates a center of the mobile robot 100. Also similarly, fault-state fall extent can be a function of the information 306 and the kinematic model 316. In at least some cases, the safety controller 258, using the kinematic model 316, is capable of determining the fault-state fall extent for any given combination of the joint-encoder data 308, the inclinometer data 310, and the reference information 312. Furthermore, the fault-state fall extent may take significantly longer than the fault-state fall direction to manifest, such as greater than one second, between one and three seconds, and/or between one and nine seconds following a fault event. The vertical reference line for the fault-state fall direction and for the fault-state fall extent, individually, can be at a center of mass of the mobile robot 100, at a center of pressure of the mobile robot 100, at a reference structure of the mobile robot 100 (e.g., at a center of the torso 104), or at another suitable position relative to the mobile robot 100.

The fault-state fall property control system may further incorporate real-time payload characterization and dynamic mass distribution analysis to enhance safety predictions and control accuracy. In some embodiments, the mobile robot 100 may include distributed weight sensors, strain gauges, inertial measurement units, and/or other sensors positioned throughout its structure to continuously monitor payload mass, center of gravity shifts, and dynamic load changes during operation. The safety controller may use this real-time payload data to dynamically update the kinematic model and recalculate fault-state fall properties as the mobile robot 100 manipulates objects of varying sizes, weights, and shapes. For asymmetric or shifting payloads, the system may implement predictive algorithms that anticipate how payload movement will affect the robot's center of mass trajectory and adjust fault-state fall direction preferences accordingly. The payload characterization system may also distinguish between different types of payloads, such as liquid containers that may slosh during movement, flexible materials that may shift unexpectedly, or multi-part assemblies that may separate during transport. Additionally, the system may incorporate payload-specific safety protocols, where certain types of hazardous or valuable materials trigger more restrictive fault-state fall property limits regardless of other operational considerations. The real-time payload analysis may also enable the mobile robot 100 to provide advance warning to nearby humans or other robots when carrying loads that significantly alter its fault-state behavior, allowing for proactive safety zone adjustments and coordinated workspace management.

In some cases, it is useful for the fault-state fall direction to be anterior relative to the torso 104. For example, when the mobile robot 100 is configured to carry a payload anteriorly relative to the torso 104 and when properties (e.g., mass, size, shape, distribution of mass, etc.) of the payload are uncertain, causing the fault-state fall direction to be anterior can reduce or eliminate the practical effect of the payload uncertainty on the fault-state fall direction. In other words, if the mobile robot 100 experiences a fault event while carrying a payload anteriorly and if the safety controller 258 is actively limiting the fault-state fall direction to being anterior, an effect of the payload properties on the fault-state fall direction can be of no consequence as it simply stacks with other variables that affect the fault-state fall direction. In other cases, it is useful for the fault-state fall direction to be posterior relative to the torso 104. This can be useful, for example, when the mobile robot 100 walks backwards to move out of a tight space because a posterior fault-state fall direction aligns with inertia of the mobile robot 100 in this case. As another example, it may be useful to control the fault-state fall extent of the mobile robot 100 to be relatively small when the mobile robot 100 has little need for a broad range of motion and/or when a close encounter between the mobile robot 100 and a human is likely, such as when the mobile robot 100 is traveling along a walkway shared with humans. In contrast, it may be useful to allow the fault-state fall extent of the mobile robot 100 to be relatively large when the mobile robot 100 has a need for a broad range of motion and/or when a close encounter between the mobile robot 100 and a human is unlikely, such as when the mobile robot 100 is confined to a workcell. Other relevant scenarios and corresponding fault-state fall properties are also possible.

The fault-state fall property control system may incorporate environmental mapping and contextual awareness to further enhance safety and operational efficiency. In some embodiments, the mobile robot 100 may maintain a dynamic environmental map that identifies zones with different safety requirements, such as areas containing fragile equipment, hazardous materials, or high-value assets. The safety controller may reference this environmental map when determining acceptable ranges for fault-state fall properties, automatically adjusting limits based on the robot's current location and nearby environmental features. For example, when operating the mobile robot 100 near precision manufacturing equipment, the system may impose more restrictive fault-state fall extent limits and/or bias fault-state fall directions away from sensitive machinery. The environmental mapping may also account for temporary obstacles, moving equipment, or changing workspace configurations detected through the robot's sensor systems. Additionally, the system may implement predictive environmental analysis, where machine learning algorithms analyze historical data about workspace usage patterns, human traffic flows, equipment placement, etc. to anticipate optimal fault-state fall property configurations for different times of day, specific operational scenarios, etc. This predictive capability may enable the mobile robot 100 to proactively adjust its safety parameters before entering different workspace zones, rather than reacting only to immediate sensor inputs, thereby providing smoother operational transitions and enhanced overall safety margins.

Movement corresponding to the motion command 300 can cause a fault-state fall property of the mobile robot 100 to change, such as to move outside of a range (e.g., an acceptable range, a target range, etc.). This can be the case for the movement when partially executed and/or when fully executed via actuators of the mobile robot 100. Correspondingly, the method 200 can include determining that a fault-state fall property has changed or will change (e.g., has moved or will move outside of an applicable range) and then responding to this determination. In this way, the computer system 254 can control operation of the mobile robot 100 proactively and/or reactively based on the fault-state fall property. In at least some cases, controlling operation of the mobile robot 100 based at least partially on a fault-state fall property occurs via independent operation of the safety controller 258 relative to the motion controller 256. Encapsulating the safety controller 258 and the motion controller 256 in separate modules can be useful to increase a speed at which the computer system 254 responds to a change in a fault-state fall property, to simplify operation of the safety controller 258, to simplify operation of the motion controller 256, to improve a reliability of the safety controller 258, to facilitate toggling operation of the safety controller 258, and/or for one or more other reasons. In a more specific example, encapsulating the safety controller 258 and the motion controller 256 in separate modules facilitate use of a machine-learning model in the motion controller 256 even when motion commands 300 are relatively unpredictable. In other embodiments, some or all operations of the safety controller 258 and the motion controller 256 can be commingled.

With reference again to FIGS. 1-4, the method 200 can include determining a property of the mobile robot 100 corresponding to the motion command 300 (block 202d). The property can be a center-of-mass property. As shown in FIG. 4, the computer system 254 can include a center-of-mass property generator 314 that uses the kinematic model 316 and the information 306 to generate one or more center-of-mass properties of the mobile robot 100 corresponding to the motion command 300. In at least some cases, the center-of-mass property generator 314 uses the reference information 312 and the inclinometer data 310 to determine a global coordinate frame for the mobile robot 100. The center-of-mass property generator 314 then uses the global coordinate frame and the kinematic model 316 to determine local coordinate frames and local centers of mass for individual links of the mobile robot 100. The center-of-mass property generator 314 then applies mass-weighted averaging to the local centers of mass to determine a global center-of-mass of the mobile robot 100. In other cases, the computer system 254 may use another suitable process to determine a global center of mass of the mobile robot 100. Furthermore, in another example, the method 200 can include determining and using local center-of-mass properties for individual links of the mobile robot 100 without determining a global center of mass of the mobile robot 100. In still other examples, the method 200 can include determining a property of the mobile robot 100 other than a center-of-mass property that is nevertheless relevant to a fault-state fall property of the mobile robot 100.

In the illustrated case, the center-of-mass property generator 314 generates a center-of-mass velocity 318 and a center-of-mass trajectory 320 of the mobile robot 100. These and other center-of-mass properties of the mobile robot 100 can be based on how the global center of mass changes as the mobile robot 100 executes movements in response to the motion command 300. Thus, the center-of-mass property generator 314 can determine center-of-mass properties of the mobile robot 100 at least partially by tracking the global center of mass of the mobile robot 100 in real time or in near real time relative to execution of these movements. In addition or alternatively, the center-of-mass property generator 314 can use visual odometry based at least partially on vision-sensor data from a vision sensor of the mobile robot 100, leg odometry based at least partially on the joint-encoder data 308, scan matching based at least partially on depth data from a depth sensor of the mobile robot 100, and/or one or more other suitable processes. Furthermore, the center-of-mass property generator 314 can generate the center-of-mass trajectory 320 only, the center-of-mass velocity 318 only, or one or more other center-of-mass properties of the mobile robot 100 in addition to or instead of the center-of-mass trajectory 320 and the center-of-mass velocity 318.

The method 200 can further include determining a condition relevant to a fault-state fall property of the mobile robot 100 (block 202e). This too can occur via the computer system 254. In the illustrated example, the condition includes a support polygon segment 322, but other conditions and condition precursors are also possible in addition to or instead of the support polygon segment 322. As an example, the method 200 can include determining a fulcrum plane in addition to or instead of determining the support polygon segment 322. Furthermore, determining the condition can include determining a fault-state fall direction component and a fault-state fall extent component of the condition. Determining the overall condition or a component thereof (e.g., a fault-state fall direction component) can be based at least partially on foot poses 324 for the feet 116a, 116b. The method 200 can include processing at least some of the information 306 with reference to the kinematic model 316 at a pose generator 326 of the computer system 254 to generate one or more local coordinate frames relevant to the condition. The pose generator 326 can use a global coordinate frame for the mobile robot 100 and the kinematic model 316 to determine the foot poses 324. The computer system 254 can also include a condition generator 328 that generates the support polygon segment 322 and/or another relevant condition from the foot poses 324. For example, the condition generator 328 can first determine an overall support polygon of the mobile robot 100 and then apply one or more filters to the overall support polygon to determine the support polygon segment 322. In at least some cases, the relevant support polygon segment 322 is anterior relative to the torso 104. Additional details regarding determining the support polygon segment 322 and other conditions relevant to fault-state fall properties of the mobile robot 100 are provided below with reference to FIGS. 5-9.

With reference again to FIGS. 1-4, the method 200 can further include comparing a center-of-mass property of the mobile robot 100 to the condition (block 202f). Relatedly, the method 200 can include determining an indication of a fault-state fall property of the mobile robot 100 (block 202g) based at least partially on a result of comparing the center-of-mass property to the condition. These operations can occur via the safety controller 258. In the illustrated case, the fault-state fall property is a fault-state fall direction 330. The computer system 254 can include a fault-state fall property generator 332 that generates the fault-state fall direction 330 based at least partially on a center-of-mass property of the mobile robot 100, such as the center-of-mass trajectory 320 alone or together with the center-of-mass velocity 318. Also in the illustrated case, the fault-state fall direction 330 is one of two fault-state fall properties. As shown in FIG. 4, the fault-state fall property generator 332 can also generate a fault-state fall extent 334. This can be in addition to or instead of generating the fault-state fall direction 330. As with generating the fault-state fall direction 330, generating the fault-state fall extent 334 can be based at least partially on a center-of-mass property of the mobile robot 100, such as the center-of-mass velocity 318 alone or together with the center-of-mass trajectory 320. Thus, determining a fault-state fall property of the mobile robot 100 and determining a corresponding condition can be based at least partially on the joint-encoder data 308 and/or the inclinometer data 310 as these data are received and interpreted by the center-of-mass property generator 314.

In at least some cases, the fault-state fall property generator 332 references the kinematic model 316, which can include information about how the mobile robot 100 responds to a fault event. Examples of this information include braking information for actuators of the mobile robot 100 and hard-stop information for joints of the mobile robot 100. As discussed in greater detail below, the manner in which the mobile robot 100 responds to a fault event may change. For example, fault-state braking for a given actuator of the mobile robot 100 may be on at some times and off at other times. Similarly, fault-state braking for a given actuator of the mobile robot 100 may have different levels at different times. Moreover, as also discussed in detail below, the computer system 254 may actively control fault-state braking of one or more actuators of the mobile robot 100 at some times to cause or at least encourage the mobile robot 100 to have a desired fault-state fall property at these times. Furthermore, determining the indication can occur while or immediately after executing movement of the mobile robot 100 corresponding to the motion command 300. Thus, the indication can correspond to the motion command 300 and can be a basis for evaluating the motion command 300 as it relates to a fault-state fall property. The indication can be a fault-state fall property itself or a derivative thereof. As an example of the latter, the indication can be a flag triggered when a fault-state fall property moves outside of an applicable range. As another example of the latter, the indication can be a composite value that accounts for multiple fault-state fall properties of the mobile robot 100.

The fault-state fall property control system may incorporate temporal safety buffering and predictive fault scenario modeling to provide enhanced protection during selected operational phases. In some embodiments, the safety controller may implement time-based safety margins that account for the finite response time required to detect fault conditions and execute protective measures. The system may continuously calculate worst-case fault scenarios based on current robot velocity, acceleration, and momentum, establishing dynamic safety buffers that expand during high-speed operations or rapid directional changes. The temporal buffering may also consider communication latencies in distributed control architectures, where safety commands propagate between remote processing units and local actuator controllers. Additionally, the system may implement predictive fault modeling that simulates potential failure modes such as actuator seizure, joint lock-up, or partial power loss, pre-calculating optimal fault-state fall properties for each scenario. This predictive approach may enable the robot to maintain safety-compliant configurations even when transitioning between different operational modes or when executing complex multi-step maneuvers. The system may also incorporate safety state caching, where previously calculated fault-state fall properties for common robot configurations are stored and rapidly retrieved to reduce computational delays during safety interventions. Furthermore, the temporal safety system may implement graduated response protocols, where the severity and immediacy of safety measures scale appropriately with the predicted time-to-impact and potential consequences of different fault scenarios.

The method 200 can also include generating a safety command 336 (block 202h) at least partially in response to determining the indication. This can occur via the computer system 254. For example, the computer system 254 can include a safety-command generator 338 that receives data for one or more fault-state fall properties of the mobile robot 100 and generates the safety command 336 based at least partially on this data. Furthermore, when the indication is a derivative of one or more fault-state fall properties of the mobile robot 100, the computer system 254 can generate the indication via the safety-command generator 338 as a precursor to generating the safety command 336. In at least some cases, the safety-command generator 338 acts as a monitor of one or more fault-state fall properties of the mobile robot 100. The safety command 336 can be an override command that causes the motion controller 256 to override at least a portion of the motion command 300. Alternatively or in addition, the safety command 336 can be a reversal command that causes the motion controller 256 to reverse at least a portion of the motion command 300. Also alternatively or in addition, the safety command 336 can be another type of command that causes the motion controller 256 to move the mobile robot 100 in another way that advantageously changes one or more fault-state fall properties of the mobile robot 100.

The method 200 can further include generating another instance of the motion command 300 based at least partially on the indication (block 202i). Generating the subsequent instance of the motion command 300 can occur via the computer system 254 at the motion controller 256 with any suitable features described herein in the context of generating the previous instance of the motion command 300. In an example, generating the subsequent instance of the motion command 300 is based at least partially on an indication of a fault-state fall direction of the mobile robot being or approaching lateral and/or posterior relative to the torso 104. In another example, generating the subsequent instance of the motion command 300 is based at least partially on an indication of a fault-state fall extent of the mobile robot 100 being or approaching a limit (e.g., 1 meter, 2 meters, 3 meters, etc.). Furthermore, the fault-state fall property of the mobile robot 100 corresponding to the indication can be based at least partially on a property of an environment in which the mobile robot 100 operates. For example, when the environment includes a walkway with different lanes used by the mobile robot 100 and humans, respectively, and a distance between the lanes is 1.5 meters, the method 200 can include limiting the fault-state fall direction of the mobile robot 100 to being anterior (or posterior) and/or limiting the fault-state fall extent of the mobile robot 100 to being 1.5 meters. Of course, countless other scenarios in accordance with various embodiments of the present technology are also possible.

As with the previous instance of the motion command 300, the method 200 can include executing movement of the mobile robot 100 corresponding to the subsequent instance of the motion command 300 (block 202j). This can occur via the same or different hardware as the hardware that actuates execution of movement of the mobile robot 100 corresponding to the previous instance of the motion command 300. Furthermore, executing movement of the mobile robot 100 corresponding to the subsequent instance of the motion command 300 can cause a fault-state fall property of the mobile robot 100 that triggered the safety command 336 to move back into an applicable range (e.g., an acceptable range, a target range, etc.). Overall, the method 200 can include implementing a control strategy for the mobile robot 100 that reliably limits one or more fault-state fall properties of the mobile robot 100. Correspondingly, the method 200 can include suppressing (e.g., without exception) deviations in one or more of these fault-state fall properties during operation of the mobile robot 100. This can be useful to facilitate operation of the mobile robot 100 in the presence of humans. Alternatively or in addition, control strategies based on one or more fault-state fall properties of the mobile robot 100 in accordance with at least some embodiments of the present technology can be useful to reduce or eliminate potential contact between the mobile robot 100 and a delicate object, to reduce or eliminate potential falling of the mobile robot 100 off a ledge (e.g., at the top of a stairway), and/or for one or more other applications.

The control strategy based on fault-state fall properties may be further enhanced by distinguishing between different temporal phases of a potential fault event. In some embodiments, the fault-state fall property generator 332 may calculate both an initial impact zone and an extended contact zone as components of the fault-state fall extent 334. The initial impact zone may correspond to areas where the mobile robot 100 would make first contact during a fault event, such as where the torso 104 or arms 110a, 110b might initially contact the ground or nearby objects. The extended contact zone may account for subsequent movements and secondary contacts as the collapse sequence progresses, including areas where the robot's appendages might sweep or where momentum transfer between links could cause additional contact points. This temporal analysis may enable the safety-command generator 338 to implement graduated safety responses, where immediate hazards in the initial impact zone trigger more urgent safety commands 336 than potential hazards in the extended contact zone. The computer system 254 may model momentum transfer between links of the mobile robot 100 during collapse using the kinematic model 316 to predict how energy dissipation and joint interactions affect the overall contact pattern. Such temporal progression analysis may allow the method 200 to provide more nuanced control of the mobile robot 100, enabling different levels of motion command modification based on the immediacy and severity of potential contact scenarios.

FIG. 5 is a perspective view of the mobile robot 100 at a time during an example of the method 200. FIG. 6 is a top plan view of foot-pose derivatives relevant to the method 200 at the time shown in FIG. 5. With reference now to FIGS. 1-6 together, the foot-pose derivatives at the time shown in FIG. 5 can include footprints 400a, 400b corresponding to respective contact patches between the feet 116a, 116b and a ground plane 402 that supports the mobile robot 100. In at least some cases, the ground plane 402 is assumed to be horizontal. The foot-pose derivatives at the time shown in FIG. 5 can further include a support polygon 404. In at least some cases, the support polygon 404 is simply a polygon formed by connecting perimeters of the footprints 400a, 400b. It can encompass the footprints 400a, 400b and a portion of the ground plane 402 between the footprints 400a, 400b. In FIG. 6 the support polygon 404 is shown within the perimeters of the footprints 400a, 400b for purposes of clarity.

When it is active and its center of mass is vertically aligned with the support polygon 404, the mobile robot 100 can remain relatively stable. As discussed above, however, the mobile robot 100 can rely on active control for stability during normal operation, including when its center of mass is vertically aligned with the support polygon 404. Relatedly, the foot-pose derivatives at the time shown in FIG. 5 can include an anterior-to-posterior fulcrum plane 406 and a lateral-to-lateral fulcrum plane 408. These fulcrum planes can define segments 410a-410d of the support polygon 404 corresponding to fault-state fall directions of the mobile robot 100. In at least some cases, the anterior-to-posterior fulcrum plane 406 and the lateral-to-lateral fulcrum plane 408 are vertical, perpendicular to one another, and individually bisect the support polygon 404. If the mobile robot 100 suddenly enters a fault state at the time shown in FIG. 5, relationships between center-of-mass properties of the mobile robot 100 and the foot-pose derivatives shown in FIG. 6 can determine the fault-state fall direction of the mobile robot 100. Relevant center-of-mass properties include position, trajectory, and velocity.

With reference again to FIG. 4, the condition generator 328 can generate a condition based at least partially on one or more of the foot-pose derivatives shown in FIG. 6. The fault-state fall property generator 332 can then compare the center-of-mass velocity 318 and/or the center-of-mass trajectory 320 to the condition to determine a fault-state fall property of the mobile robot 100. For example, the fault-state fall property generator 332 may determine that, based on the center-of-mass velocity 318 and/or the center-of-mass trajectory 320 at the time shown in FIG. 5, a fault event at this time will result in a center of mass of the mobile robot 100 remaining in or moving to vertical alignment with the segment 410a. Based on this, the fault-state fall property generator 332 may further determine that the fault-state fall direction 330 of the mobile robot 100 is anterior and leftward. As discussed in greater detail above, the method 200 can include controlling the mobile robot 100 to prevent and/or mitigate undesirable changes in one or more fault-state fall properties of the mobile robot 100. In at least some cases, the fault-state fall property generator 332 tracks a fault-state center of mass of the mobile robot 100 that relates in a known way to one or more other center-of-mass properties of the mobile robot 100 at any given time.

The fault-state center of mass of the mobile robot 100 may manifest during and/or after a fault event. Hardware aspects of the mobile robot 100 may cause a collapse behavior of the mobile robot 100 to be predictable enough for the fault-state center of mass to be a known function of current-state variables, such as current-state center-of-mass properties and current-state foot-pose derivatives. For example, actuators operably associated with joints of the legs 112a, 112b can be configured to default to a locked or heavily braked state. Although this may tend to increase the fault-state fall extent 334, it may nevertheless be useful to cause a relationship between the center-of-mass trajectory 320 and the anterior-to-posterior fulcrum plane 406 to be highly determinative of whether the fault-state fall direction 330 is anterior or posterior. The fault-state fall property generator 332 can use this relationship to determine the fault-state fall direction 330. In another example, actuators operably associated with joints between the arms 110a, 110b and the torso 104 can be configured to default to an unlocked and unbraked state. In these and other cases, the fault-state fall property generator 332 can determine the fault-state fall direction 330 based at least partially on reaction moments of the arms 110a, 110b that are known functions of the pose of the mobile robot 100 at the time of the fault event in the absence of a payload. These and other fault-state hardware features of the mobile robot 100 can be part of the kinematic model 316 and/or present at one or more other suitable portions of the safety controller 258. Furthermore, fault-state behaviors (e.g., braking) of hardware (e.g., actuators) of the mobile robot 100 may change. The computer system 254 can update the kinematic model 316 accordingly.

The fault-state fall property generator 332 may implement collapse sequence modeling to enhance the accuracy of fault-state fall property predictions. In some embodiments, the system may calculate a predicted fault-state collapse sequence that models the temporal progression of joint movements and link positions that would occur following a fault event. This modeling may account for gravitational effects on individual links of the mobile robot 100 after loss of active control, considering factors such as link mass distribution, joint friction characteristics, and momentum transfer between connected components. The predicted collapse sequence may simulate how each link would move under gravitational forces over time, accounting for the sequential nature of joint failures and the cascading effects as upper body components transfer momentum to lower body components during the collapse. For example, the system may model how the torso 104 would initially rotate about hip joints, followed by knee joint buckling under the combined weight of the torso 104 and upper leg components, and finally the impact and settling of various robot components on the ground plane 402. This temporal simulation may enable the fault-state fall property generator 332 to determine not only initial impact zones but also extended contact zones that account for secondary movements and momentum dissipation throughout the complete collapse sequence. The predicted collapse sequence may be updated in real time as the mobile robot 100 changes pose such that fault-state fall property calculations remain accurate across the full range of operational configurations.

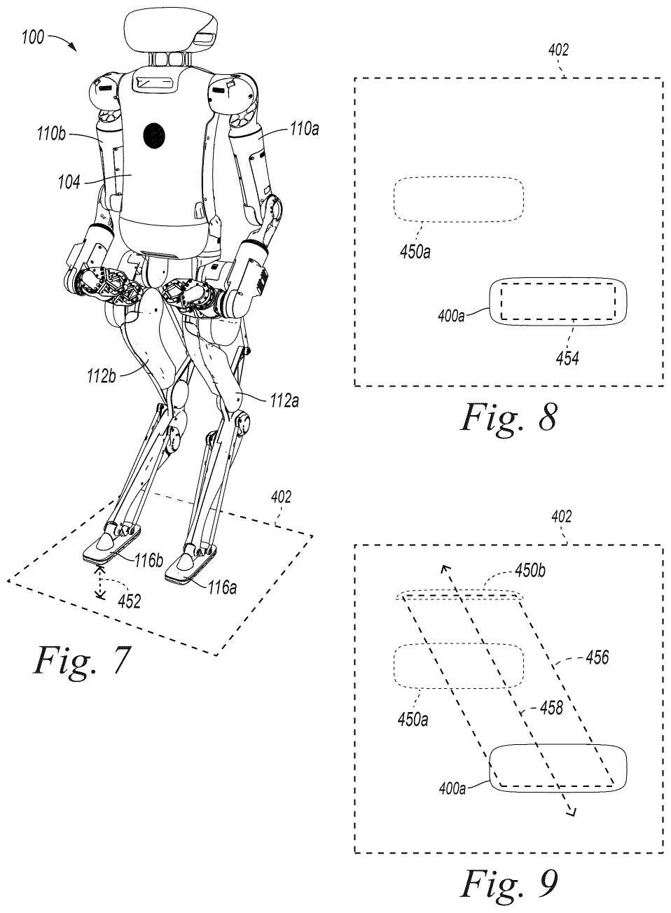

Determining foot-pose derivatives relevant to fault-state fall properties of the mobile robot 100 is possible even when one of the feet 116a, 116b is out of contact with the ground plane 402. FIGS. 7-9 illustrate this scenario. In particular, FIG. 7 is a perspective view of the mobile robot 100 at a time during an example of the method 200 when the foot 116a is in contact with the ground plane 402 and the foot 116b is out of contact with the ground plane 402. FIGS. 8 and 9 are top plan views of foot-pose derivatives relevant to the method 200 at the time shown in FIG. 7. With reference now to FIGS. 1-9 together, when the foot 116a is in contact with a ground surface and the foot 116b is out of contact with the ground surface, as shown in FIG. 7, the method 200 can include generating a projection of the foot 116b onto the ground surface. Correspondingly, the foot-pose derivatives at the time shown in FIG. 7 can include the footprint 400a corresponding to the foot 116a and projections (individually, a direct projection 450a and an offset projection 450b) corresponding to the foot 116b. The direct projection 450a can be a vertical projection of a contact surface of the foot 116b onto the ground plane 402. The offset projection 450b can be a derivative of the direct projection 450a that also accounts for a height 452 of the foot 116b above the ground plane 402. In at least some cases, the offset projection 450b corresponds to a portion of the foot 116b that would contact the ground plane 402 during a fall event that begins with lateral falling of the mobile robot 100 in the direction of the foot 116b, such as rightward falling in the illustrated case. This can be a function of a distance between the footprint 400a and the direct projection 450a in addition to being a function of the height 452. Moreover, a counterpart of the offset projection 450b can be a function of an angle of the foot 116b (e.g., in yaw and/or pitch dimensions) when the contact surface of the foot 116b is not parallel to the ground plane 402.

Thus, the method 200 can include determining the condition for comparison with a center-of-mass property of the mobile robot 100 based at least partially on a pose of the foot 116a in contact with the ground plane 402 and the direct projection 450a, the offset projection 450b, and/or another suitable derivative of a pose of the foot 116b spaced apart from the ground plane 402. As shown in FIGS. 8 and 9, foot-pose derivatives relevant to fault-state fall properties of the mobile robot 100 at the time shown in FIG. 7 can include a support polygon 454, a fall-contact polygon 456, and a skewed anterior-to-posterior fulcrum plane 458. The support polygon 454 can be substantially the same as the footprint 400a. The fall-contact polygon 456, in contrast, can be a polygon formed by connecting perimeters of the footprint 400a and the offset projection 450b. It can encompass the footprint 400a, the offset projection 450b, and a portion of the ground plane 402 therebetween. In FIG. 8, the support polygon 454 is shown within the perimeter of the footprint 400a for purposes of clarity. Similarly, in FIG. 9, the fall-contact polygon 456 is shown within the perimeters of the footprint 400a and the offset projection 450b for purposes of clarity. In at least some cases, the skewed anterior-to-posterior fulcrum plane 458 is vertical and bisects the fall-contact polygon 456. The skewed anterior-to-posterior fulcrum plane 458 can have any of the features described above for the anterior-to-posterior fulcrum plane 406. In contrast, a counterpart of the lateral-to-lateral fulcrum plane 408 may be absent when one of the feet 116a, 116b is out of contact with the ground plane 402. This can be the case, for example, when shifting a fault-state center of mass of the mobile robot 100 to the support polygon 454 would be impractical. In these and other cases, the fault-state fall property generator 332 can differentiate between anterior and posterior fault-state fall directions without accounting for lateral fault-state fall directions or while assuming that the lateral fault-state fall direction is always toward the one of the feet 116a, 116b that is out of contact with the ground plane 402.

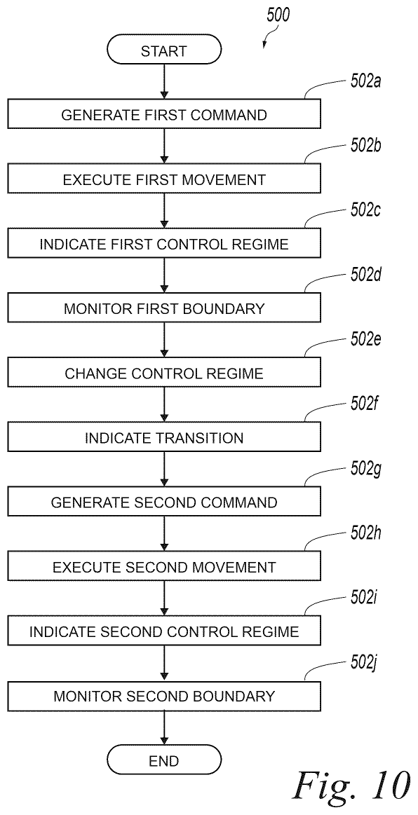

As discussed above, controlling the mobile robot 100 based on a fault-state fall property can involve trade-offs. For example, this type of control may enhance safety in an environment in which the mobile robot 100 works near humans while also limiting functional capabilities of the mobile robot 100. For at least this reason, it can be useful to operate the mobile robot 100 under two or more different control regimes at different times. FIG. 10 is a block diagram corresponding to a method 500 in accordance with at least some embodiments of the present technology that includes this feature. The diagram includes blocks 502a-502j corresponding to different respective portions of the method 500. The method 500 is described below primarily in the context of FIGS. 1, 3 and 4 and can include any suitable features described above for the method 200.

With reference now to FIGS. 1, 3, 4 and 10 together, the method 500 can include generating the motion command 300 under a first control regime that includes a limit selected to urge a fault-state fall property of the mobile robot 100 toward a desirable range, even when other control of the mobile robot 100 may cause the fault-state fall property to move outside of that range. For example, the limit can include a step-height rule that restricts respective heights of the feet 116a, 116b above a ground surface while the mobile robot 100 walks. This can reduce or eliminate operation or the mobile robot 100 in a state in which the lateral fault-state fall direction is impractical to control. In addition or alternatively, the limit can include a leg-extension rule that restricts an extension of a leg of the mobile robot. In this or another suitable manner, the mobile robot 100 can implement a crouching gait. When implementing this gait, a center-of-mass of the mobile robot 100 can remain relatively low, which, in turn, can cause a fault-state fall extent of the mobile robot 100 to be relatively small. Such a crouching gait also may tend to be energetically inefficient. Accordingly, the mobile robot 100 may change a balance of efficiency and fault-state fall extent depending on circumstances. For example, the leg-extension limit may be directly proportional to a distance between the mobile robot 100 and a human.

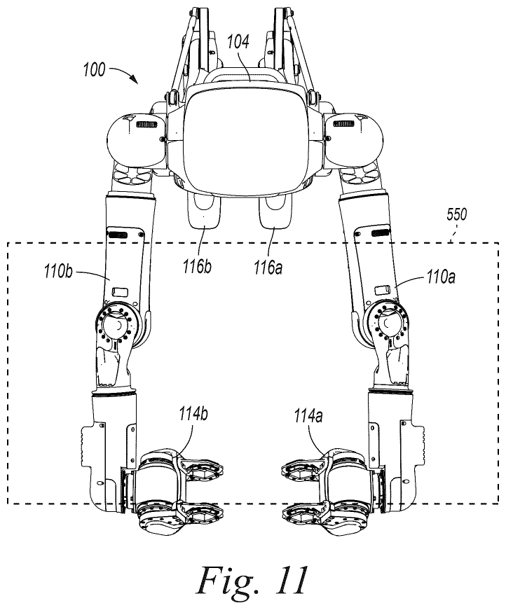

As yet another example, the limit can include a foot-orientation rule that restricts respective orientations of the feet 116a, 116b. For example, the foot-orientation rule may call for an orientation of one or both of the feet 116a, 116b to remain anterior relative to the torso 104. This can be useful, for example, to urge the fault-state fall direction toward also being anterior relative to the torso 104. Likewise, the limit can include an arm-extension rule that restricts an extension of the arms 110a, 110b. This too can urge the fault-state fall direction toward being anterior relative to the torso 104. FIG. 11 is a top plan view of the mobile robot 100 and a representation 550 of an arm-extension rule. As shown in FIG. 11, the arm-extension rule can define a region corresponding to the representation 550 where tool center points of the end effectors 114a, 114b are permitted to be at any given time. The region can be anterior to and spaced apart from the torso 104. In at least some cases, reaction moments of the arms 110a, 110b urge the fault-state fall direction toward being anterior relative to the torso 104 when the mobile robot 100 is in a fault state and the tool center points of the end effectors 114a, 114b are within this region.

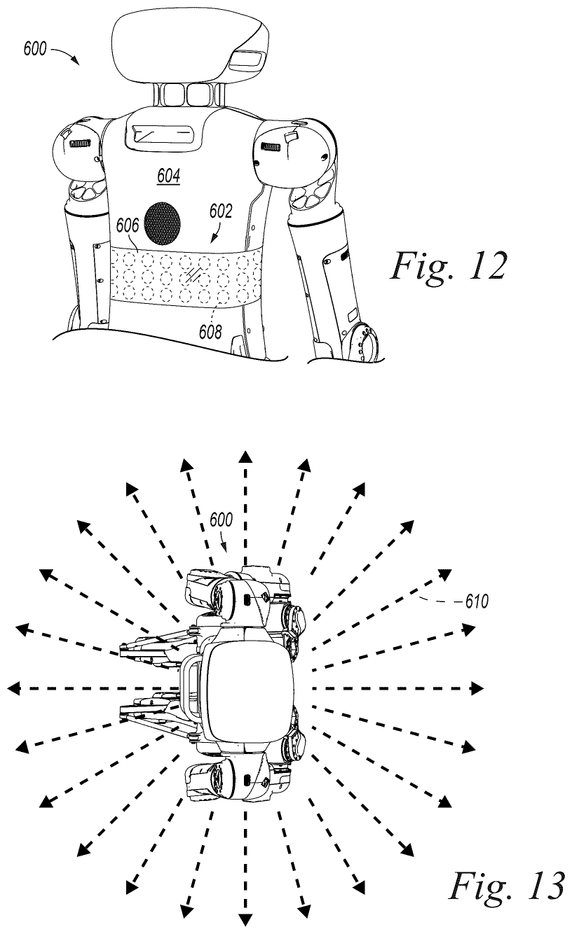

With reference again to FIGS. 1, 3, 4 and 10 together, the method 500 can include executing movement of the mobile robot 100 corresponding to the motion command 300 (block 502b) via an actuator of the mobile robot 100. The method 500 can also include indicating operation of the mobile robot 100 under the first control regime (block 502c) while executing this movement. In at least some cases, the indication is visual and intended for perception by humans near the mobile robot 100. Relatedly, the mobile robot 100 can include an indicator. FIG. 12 is a partial perspective view of a mobile robot 600 in accordance with at least some embodiments of the present technology. The mobile robot 600 can include features the same as or similar to those of the mobile robot 100. As shown in FIG. 12, the mobile robot 600 can include an indicator 602 at a torso 604 similar to the torso 104 of the mobile robot 100. The indicator 602 can include a window 606 and light sources 608 (one labeled) configured to project light outwardly from the torso 604 via the window 606. FIG. 13 is a top plan view of the mobile robot 600 and a representation of visual projections 610 during an example of the method 500.

Visually indicating operation of the mobile robot 600 under the first control regime can include visually distinguishing relative hazards of two or more different directions of approaching the mobile robot 600 while executing movement of the mobile robot 600 corresponding to the motion command 300 generated under the first control regime. For example, this can include visually indicating a hazard of approaching the mobile robot 600 from an anterior side relative to the torso 604 as greater than a hazard of approaching the mobile robot 600 from a lateral side relative to the torso 604. In addition or alternatively, this can include visually indicating a hazard of approaching the mobile robot 600 from the anterior side relative to the torso 604 as greater than a hazard of approaching the mobile robot 600 from a posterior side relative to the torso 604. The indicator 602 can extend around most or all of a circumference of the mobile robot 600 in a horizontal plane. The light sources 608 and visual projections 610 at different circumferential positions around the mobile robot 600 can have different properties to visually distinguish relative hazards. For example, anterior ones of the light sources 608 and visual projections 610 can be red, lateral ones of the light sources 608 and visual projections 610 can be yellow, and posterior ones of the light sources 608 and visual projections 610 can be green when the mobile robot 600 is operating under a control regime in which a fault-state fall direction of the mobile robot 600 is controlled to be anterior.

The method 500 can also include monitoring for breach of a boundary around the mobile robot 600 (block 502d) while executing movement of the mobile robot 600 corresponding to the motion command 300. Breach of the boundary can cause a safety-related response in the mobile robot 600. For example, the mobile robot 600 may stop traveling or executing a behavior after the breach. Monitoring for the breach can occur via a sensor of the mobile robot 100. Examples of sensors are described below with reference to FIG. 15. The boundary can correspond to the applicable control regime. For example, when a control regime of the mobile robot 100 causes the fault-state fall direction to be anterior, the boundary can extend farther in an anterior direction than in a posterior direction. Correspondingly, no breach may occur when a human is present behind the mobile robot 100 while the mobile robot 100 operates under a control regime in which a posterior fault-state fall direction of the mobile robot 100 is inhibited within practical limits. This can greatly improve the efficiency of the mobile robot 100 in collaborative environments. The control regime can even be responsive to the presence of a nearby human. For example, with reference now to FIGS. 5 and 6, after the mobile robot 100 stops when a human is detected, it can change the segment 410a-410d with which the fault-state center of mass is aligned to be the segment circumferentially opposite to the human. This can be useful, for example, when a human passes by the mobile robot 100 in a narrow aisle. With reference now to FIGS. 12 and 13, the light sources 608 and visual projections 610 can confirm circumferentially shifting of a safe zone around the mobile robot 600 to a human in real time or in near real time during such an encounter.

With reference again to FIGS. 1, 3, 4 and 10 together, the method 500 can further include changing the mobile robot 100 to a second control regime via the computer system 254 (block 502e). The first and second control regimes can be characterized by one or more differences in a fault-state fall property of the mobile robot 100. For example, when the first control regime limits the fault-state fall direction of the mobile robot 100 to being anterior, the second control regime can limit the fault-state fall direction of the mobile robot 100 to being posterior. Similarly, when the first control regime imposes another limit related to a fault-state fall property of the mobile robot 100 as discussed above (e.g., the step-height rule, the leg-extension rule, the foot-orientation rule, the arm-extension rule, etc.), the second control regime can remove or relax the limit. Furthermore, the first and second control regimes can impose different limits. As another example, when the first control regime limits the fault-state fall extent of the mobile robot 100 to a first distance, the second control regime can limit the fault-state fall extent of the mobile robot 100 to a second distance different than the first distance. In a more specific example, the second distance is greater than the first distance, such as at least 1.5 times the first distance. Moreover, the second control regime can simply eliminate a limit on a fault-state fall property (e.g., direction and/or extent) of the mobile robot 100 imposed under the first control regime. Also, the second control regime can impose a variable limit, such as a proportional limit corresponding to another variable. For example, as mentioned above, a leg-extension limit under the second control regime may be directly proportional to a distance between the mobile robot 100 and a human.

The method 500 may further include monitoring a task completion status of the mobile robot 100, such as tracking progress through a sequence of manipulation tasks, navigation waypoints, or operational objectives. In some cases, changing the mobile robot 100 to the second control regime may occur in response to a change in the task completion status, such as when the mobile robot 100 completes a collaborative task requiring restrictive fault-state fall property limits and transitions to an independent task that permits more operational freedom. For example, the mobile robot 100 may operate under the first control regime while performing precision assembly work near human operators, then automatically transition to the second control regime upon completing the assembly task and beginning autonomous material transport in a segregated area. The computer system 254 may determine task completion status based on sensor feedback confirming successful object manipulation, receipt of task completion signals from external systems, achievement of predetermined performance metrics associated with the current operational objective, and/or other suitable indicators.

The method 500 can also include visually indicating a transition from operation of the mobile robot 100 under the first control regime to operation of the mobile robot 100 under the second control regime. This can occur after executing movement of the mobile robot 100 corresponding to the motion command 300 under the first control regime. In the context of the mobile robot 600, the indication can occur via the indicator 602. For example, all of the light sources 608 may flash to indicate the transition. In at least some cases, the mobile robot 600 may further indicate the transition with sound, such as by emitting an alarm and/or a recorded warning message. Furthermore, the mobile robot 600 may remain in a substantially stationary state while indicating the transition. This can be useful, for example, to provide humans near the mobile robot 600 during the transition with sufficient time to move away. The substantially stationary period can last for at least one second, such as between one second and 10 seconds.

With reference again to FIGS. 1, 3, 4 and 10, the mobile robot 100 can perform operations after transitioning to the second control regime similar to the operations described above for the first control regime. For example, the mobile robot 100 can generate another instance of the motion command 300 via the computer system 254 (block 502g). In at least some cases, generating an instance of the motion command 300 under the second control regime occurs via a machine-learning model that is less predictable than a model used to generate a previous instance of the motion command 300 under the first control regime. This can be the case, for example, when a limit imposed under the first control regime is relaxed or absent under the second control regime. The method 500 can still further include executing movement of the mobile robot 100 corresponding to the subsequent instance of the motion command 300 (block 502h) and indicating operation of the mobile robot 100 under the second control regime (block 502i) while executing this movement. The method 500 can also include monitoring for breach of a second boundary around the mobile robot 100 (block 502j) while executing the movement. In at least some cases, the first and second boundaries are different. For example, the second boundary may be farther from the mobile robot 100 when the second control regime is for operation of the mobile robot 100 in an environment in which humans are not expected to be present.

In general, safety control regimes, operating states, etc. of the mobile robot 100 in methods in accordance with at least some embodiments of the present technology can be proactive and/or reactive. Proactively, the computer system 254 may generate motion commands and/or fault-state braking for one or more actuators of the mobile robot 100 in advance to cause or at least encourage the mobile robot 100 to have different fault-state fall properties at different times. Reactively, the computer system 254 may monitor sensor data from operation of the mobile robot 100 in real time or near real time and implement different strategies for responding to these data under the different safety control regimes, operating states, etc.

A coordination system may also implement priority-based fault-state fall property management when multiple robots operate in shared workspaces with varying operational requirements. In some embodiments, robots carrying hazardous materials, fragile payloads, or high-value items may be assigned higher priority levels that influence fault-state fall property negotiations with nearby robots. For example, when a high-priority robot approaches a shared workspace, lower-priority robots may automatically adjust their fault-state fall directions to create safe corridors or evacuation paths, even if this requires temporary operational constraints or route modifications. The priority system may also consider task urgency, with robots performing time-critical operations receiving precedence. In addition or alternatively, the priority system may consider payload characteristics. The priority levels may be determined based at least partially on hazard levels of payloads carried by the mobile robots, with robots carrying more hazardous payloads such as toxic chemicals, flammable materials, or radioactive substances assigned higher priority levels than robots carrying less hazardous payloads such as standard consumer goods or non-critical components. When priority-based coordination is active, higher-priority robots may maintain their preferred fault-state fall behaviors while lower-priority robots modify their fault-state behaviors, such as to create safe evacuation paths or buffer zones around the higher-priority units, even if such modifications require temporary operational constraints or alternative routing decisions. Additionally, the system may implement dynamic priority adjustment based on real-time conditions, such as elevating the priority of a robot experiencing mechanical issues or operating near its performance limits. Furthermore, the system may incorporate hierarchical coordination structures, where area supervisors or fleet management systems can override local robot-to-robot negotiations when broader operational objectives require specific fault-state fall property configurations. This multi-layered approach may enable complex multi-robot operations while maintaining predictable and safe fault-state behaviors across an entire robotic fleet.

Methods, devices, and systems in accordance with at least some embodiments of the present technology may include multi-robot coordination capabilities that enable safe and efficient operation of multiple mobile robots in shared workspaces. In some embodiments, a fleet management system may coordinate fault-state fall properties among a plurality of mobile robots by facilitating communication of fault-state fall property information between the robots. This shared information may include current fault-state fall directions, fault-state fall extents, and real-time updates to fault-state behaviors of individual robots. The coordination system may implement algorithms that assign complementary fault-state fall directions to neighboring robots to create safe corridors in shared workspaces, reducing the likelihood of overlapping hazard zones during potential fault events. For example, when two robots are operating in proximity, the system may configure one robot to have an anterior fault-state fall direction while configuring the adjacent robot to have a posterior fault-state fall direction, thereby creating a buffer zone between their respective potential contact areas.

The multi-robot coordination system may implement priority-based fault-state fall property management where robots are assigned different priority levels based on their operational characteristics. Higher-priority robots, such as those carrying hazardous materials, fragile payloads, or high-value items, may be given precedence in fault-state fall direction selection, with lower-priority robots automatically adjusting their fault-state behaviors to accommodate the safety requirements of higher-priority units. The priority system may also consider task urgency, with robots performing time-critical operations receiving precedence in workspace navigation and fault-state fall property coordination. Additionally, the system may implement dynamic priority adjustment based on real-time conditions, such as elevating the priority of a robot experiencing mechanical issues or operating near its performance limits. In some embodiments, the coordination system may maintain a dynamic environmental map of the shared workspace that identifies zones with different safety requirements and operational constraints. Among other things, the dynamic environmental map may categorize different areas of the workspace based on their safety criticality, such as zones containing precision manufacturing equipment, hazardous materials storage, high-value assets, or areas with restricted clearances that require more conservative fault-state fall extents. Furthermore, the coordination system may continuously monitor payload characteristics of mobile robots in the fleet, including payload mass, center of gravity shifts, load distribution changes, etc. and dynamically update fault-state fall property coordination based on real-time changes in these payload parameters across multiple robots. When one robot's payload characteristics change significantly—such as when picking up or depositing heavy items—the system may automatically recalculate fault-state fall property assignments for nearby robots to account for the altered dynamics and ensure that coordinated safety zones remain appropriate for the updated fleet configuration.

Individual mobile robots in a fleet may reference a shared environmental map when determining acceptable ranges for fault-state fall properties, automatically adjusting limits based on the robot's current location within the mapped zones—for example, implementing more restrictive fault-state fall extent limits when operating near sensitive machinery or biasing fault-state fall directions away from fragile equipment or valuable inventory. Furthermore, the environmental map may be shared among all robots in the fleet and continuously updated based on sensor data from multiple robots, enabling coordinated adjustments to fault-state fall property limits based on each robot's current location and nearby environmental features. The system may implement hierarchical coordination structures where area supervisors or fleet management systems can override local robot-to-robot negotiations when broader operational objectives require specific fault-state fall property configurations. Furthermore, the multi-robot system may incorporate adaptive learning mechanisms that analyze operational data from across the entire fleet to refine fault-state fall property coordination strategies, enabling robots to share learned safety optimizations and collectively improve their coordination algorithms over time.

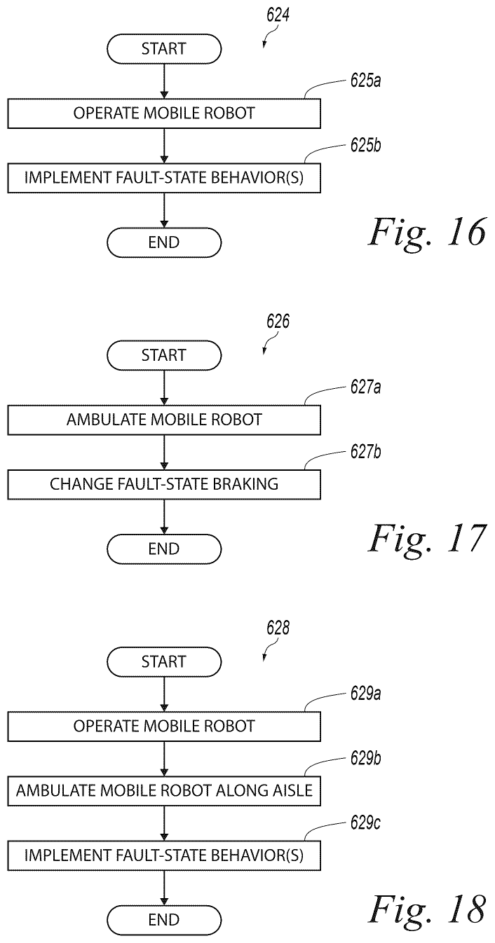

FIGS. 14-18 are block diagrams corresponding to additional respective methods in accordance with at least some embodiments of the present technology. In particular, FIG. 14 corresponds to a method 620 and includes blocks 621a-621d corresponding to different respective portions of the method 620. FIG. 15 corresponds to a method 622 and includes blocks 623a-623d corresponding to different respective portions of the method 622. FIG. 16 corresponds to a method 624 and includes blocks 625a, 625b corresponding to different respective portions of the method 624. FIG. 17 corresponds to a method 626 and includes blocks 627a, 627b corresponding to different respective portions of the method 626. Finally, FIG. 18 corresponds to a method 628 and includes blocks 629a-629c corresponding to different respective portions of the method 628. When suitable, the features described herein of any operations within any one of the methods 200, 500, 620, 622, 624, 626, 628 are also applicable to the same or similar operations in any other one of the methods 200, 500, 620, 622, 624, 626, 628.

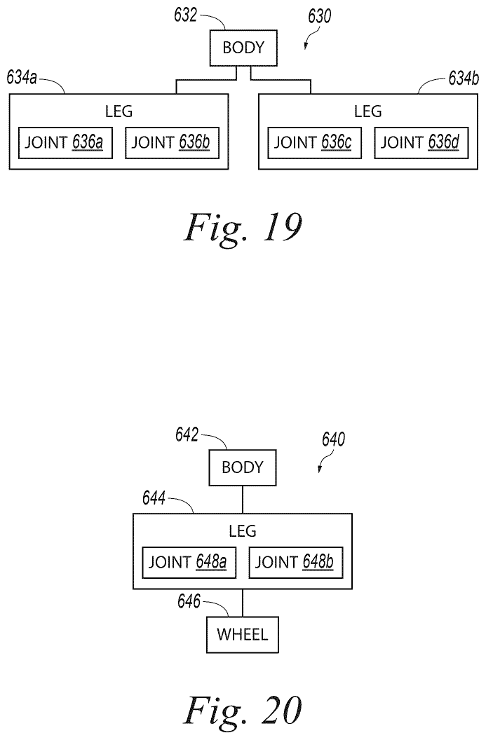

FIGS. 19-21 are block diagrams corresponding to different respective configurations of mobile robots in accordance with at least some embodiments of the present technology. These configurations may be referenced in descriptions of various embodiments of the methods 620, 622, 624, 626, 628. In particular, FIG. 19 shows a mobile robot 630 including a body 632 and legs 634 (individually identified as legs 634a, 634b) configured to support at least a portion of a weight of the body 632. The mobile robot 630 can further include joints 636 (individually identified as joints 636a-636d). The joints 636a, 636b can be at the leg 634a with a kinematically intervening link (not shown). Similarly, the joints 636c, 636d can be at the leg 634b with a kinematically intervening link (also not shown). The configuration of the mobile robot 630 can be similar to or the same as the configuration of the mobile robot 100 (FIG. 1). As another example, FIG. 20 shows a mobile robot 640 including a body 642, a leg 644 configured to support at least a portion of a weight of the body 642, and a wheel 646 also configured to support at least a portion of a weight of the body 642. The body 642 can be connected to the wheel 646 via the leg 644. The mobile robot 640 can further include joints 648 (individually identified as joints 648a, 648b) at the leg 644.

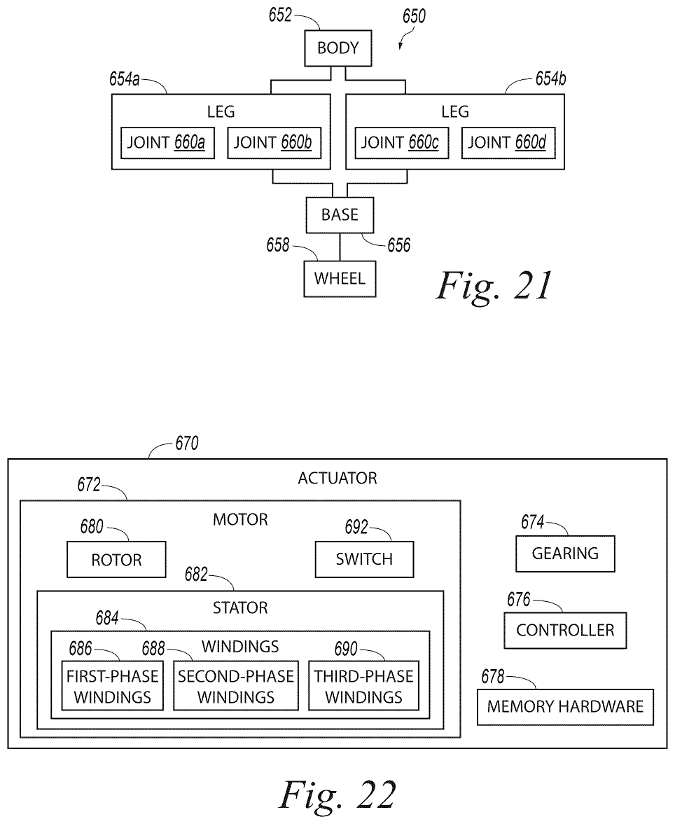

As yet another example, FIG. 21 shows a mobile robot 650 including a body 652 and legs 654 (individually identified as legs 654a, 654b) configured to support at least a portion of the body 652. The mobile robot 650 can further include a base 656 and a wheel 658 connected to the body 652 via the base 656. Furthermore, the wheel 658 can be connected to the body 652 via the legs 654a, 654b in parallel. The mobile robot 650 can further include joints 660 (individually identified as joints 660-660d). The joints 660a, 660b can be at the leg 654a with a kinematically intervening link (not shown). Similarly, the joints 660c, 660d can be at the leg 654b with a kinematically intervening link (also not shown). With reference to FIGS. 19-21 together, the mobile robot 630 can be legged whereas the mobile robots 640, 650 are wheeled. Thus, the mobile robot 630 can be configured to ambulate via the legs 634. In contrast, the mobile robots 640, 650 can be configured to move via interaction between the wheels 646, 658, respectively, and a ground surface. Furthermore, the mobile robots 640, 650 can include additional wheels. Nevertheless, all of the mobile robots 630, 640, 650 can be configured to be dynamically stable during normal operation. For example, even when the mobile robots 640, 650 each include three, four, or more wheels, the wheel bases can be small relative to the corresponding bodies 642, 652.

FIG. 22 is a block diagram corresponding to an actuator 670 of a mobile robot in accordance with at least some embodiments of the present technology. With reference to FIGS. 19-22, the mobile robots 630, 640, 650 individually can include one or more actuators corresponding to the actuator 670. For example, the mobile robot 630 can include such actuators configured to actuate radial motion at the joints 636a-636d, respectively. Similarly, the mobile robot 640 can include such actuators configured to actuate radial motion at the joints 648a-648b, respectively. Also similarly, the mobile robot 650 can include such actuators configured to actuate radial motion at the joints 660a-660d, respectively. The mobile robots 630, 640, 650 can include these actuators at the corresponding joints or otherwise operably associated with the corresponding joints, such as via cranks and connection rods. For simplicity, the reference number “670” may be used in conjunction with various actuators corresponding to different respective joints of mobile robots in accordance with at least some embodiments of the present technology.

As shown in FIG. 22, the actuator 670 can include a motor 672 and gearing 674 operably associated with one another. The gearing 674 can be configured to change an output of the motor 672, such as by reducing the speed and increasing the torque. The gearing 674 can be cycloidal, strain-wave, planetary, or of another suitable type. The actuator 670 can further include a controller 676 and memory hardware 678, which can be at the actuator 670 or separate from the actuator 670 and operably associated with the actuator 670 via communication hardware. Accordingly, the mobile robots 630, 640, 650 can include the controller 676 and memory hardware 678 as components of the constituent actuators or as separate components operably associated with the constituent actuators. Furthermore, the controller 676 and memory hardware 678 can have any suitable attributes, functions, properties, etc. of any other similar computing features described herein. With reference again to FIG. 22, the motor 672 can include a rotor 680 and a stator 682 configured to rotate the rotor 680 about an axis. As a portion of the rotor 680, the motor 672 can include windings 684. In at least some cases the motor 672 is a three-phase motor. Accordingly, the windings 684 can include first-phase windings 686, second-phase windings 688, and third-phase windings 690.

As shown in FIG. 22, the motor 672 can further include a switch 692 operably associated with the windings 684. The switch 692 can be a relay that changes state in response to one or more signals from the controller 676. In these and other cases, the switch 692 can be configured to short circuit the windings 684. For example, the switch 692 can be configured to short circuit just a portion of the windings 684. The motor 672 can include additional switches (not shown) configured to short circuit other portions of the windings 684. In an example, the switch 692 is configured to short circuit the first-phase windings 686, the motor 672 includes another switch configured to short circuit the second-phase windings 688, and the motor 672 includes yet another switch configured to short circuit the third-phase windings 690. In another example, the switch 692 is configured to short circuit a portion (e.g., about half) of the first-phase windings 686 and the motor 672 includes another switch configured to short circuit another portion of the first-phase windings 686. Still further, the switch 692 and/or another switch can be configured to short circuit the windings 684 by electrically connecting windings of different phases to one another. As described below, short circuiting the windings 684 can cause back electromotive force braking of the actuator 670 in the absence of power. Changing the short circuiting can change the level of this back electromotive force braking. For example, short circuiting just the first-phase windings 686 can cause less back electromotive force braking than short circuiting both the first-phase windings 686 and the second-phase windings 688. Accordingly, the controller 676 can change the level of back electromotive force braking of the actuator 670 near instantaneously by controlling the switch 692 and any additional switches.

In the discussion herein of various features of the methods 200, 500, 620, 622, 624, 626, 628, the mobile robots 100, 600, 630, 640, 650 and features thereof may be referenced separately or collectively. In both cases, it should be understood that the described features can be practiced via any compatible ones of the mobile robots 100, 600, 630, 640, 650. For example, a reference herein to the mobile robot 630 should be construed as a reference to the mobile robot 630 or any compatible one of the mobile robots 100, 600, 630, 640, 650. Similarly, a reference herein to the leg 634a of the mobile robot 630 should be construed as a reference to the same or a similar features of any compatible one of the mobile robots 100, 600, 630, 640, 650.

With reference now to FIGS. 1, 14 and 19-22 together, the method 620 can include operating the mobile robot 630 in an environment (block 622a). This can occur while the mobile robot 630 is in a dynamically stable state. Furthermore, the mobile robot 630 can include a battery (not shown) electrically connected to the actuator 670 during the operation. Still further, the actuator 670 can draw power from the battery during the operation. As discussed above, a power supply of the mobile robot 630, such as that from the battery to the actuator 670, can be subject to interruption during a fault state of the mobile robot 630. As an example, an intentional interruption may occur when an operator triggers a hard stop of the mobile robot 630 or when a hard stop of the mobile robot 630 occurs automatically because of an unsafe condition. As another example, an unintentional interruption may occur when the battery is unexpectedly depleted or damaged. In at least some cases, the manner in which the mobile robot 630 responds to a fault state depends on the presence or absence of a human in the environment and/or a related variable. Relatedly, the method 620 can include sensing a human in the environment (block 622a) while operating the mobile robot 630. This can include sensing a presence of the human and/or sensing a variable related to the human. Examples of variables include location, velocity, and state (e.g., encumbered or encumbered). The location of the human can be relative to a suitable reference frame in which the mobile robot 630 can also determine its own location.

In an example, sensing a human includes capturing sensor data corresponding to the human via one or more sensors of the mobile robot 630. The captured sensor data can include LiDAR (Light Detection and Ranging) data, stereoscopic data, RGB (Red, Green, Blue) data, SONAR (Sound Navigation and Ranging) data, and/or data of one or more other suitable types. The method 620 can further include providing this data to a machine-learning model (e.g., a convolutional neural network) trained to recognize humans. In at least some cases, the method 620 includes pre-processing the sensor data, such as by filtering irrelevant data and/or by fusing relevant data from two or more different sensing modalities. Sensing the location, velocity, and/or other variables related to a human can use the same or different sensor data. For example, the method 620 can include processing sensor data on a human via a SLAM (Simultaneous Localization and Mapping) algorithm. The method 620 can further include sensing different locations of the human at different respective times and using the locations and an elapsed time between sensing the locations to determine a velocity of the human. Other approaches to collecting and processing sensor data on a human are also possible.

As shown in FIG. 14, the method 620 can further include changing a fault-state behavior of the actuator 670 (block 622c). In at least some cases, this includes changing a fault-state behavior of the actuator 670 based at least partially on sensing a human in the environment. For example, changing the fault-state behavior of the actuator 670 can be based at least partially on sensing a presence, location, and/or velocity of a human in the environment. The fault-state behavior of the actuator 670 can be a fault-state braking, such as a fault-state back electromotive force braking in the absence of power from a battery of the mobile robot 630. Accordingly, changing the fault-state behavior of the actuator 670 can include changing a fault-state behavior of the switch 692. Similarly, changing the fault-state behavior of the actuator 670 can include changing respective fault-state behaviors of the switch 692 and/or of other switches of the motor 672. In at least some cases, this includes causing respective fault-state behaviors of the switch 692 and of at least one other switch of the motor 672 to be different. For example, changing the fault-state behavior of the actuator 670 can include causing a fault-state behavior of a switch configured to short circuit the first-phase windings 686 to be on and causing a fault-state behavior of a switch configured to short circuit the second-phase windings 688 to be off. The method 620 can include storing a fault-state behavior of the actuator 670 (e.g., respective fault-state behaviors of the switch 692 and/or of other switches of the motor 672) in the memory hardware 678. Thus, changing the fault-state behavior of the actuator 670 can include updating this information in the memory hardware 678.

Changing the fault-state behavior of the actuator 670 can occur while most of a total mass of the mobile robot 630 and any payload carried by the mobile robot 630 is above a joint corresponding to the actuator 670. In these and other cases, the fault-state behavior of the actuator 670 can correspond to a fault-state fall property (e.g., direction, extent, etc.) of the mobile robot 630. Moreover, the actuator 670 can be one of several. In such cases, a relationship between respective fault-state behaviors of the actuators 670 can correspond to a fault-state fall property (e.g., direction, extent, etc.) of the mobile robot 630. Furthermore, immediately after changing a fault-state behavior of a given one of the actuators 670, a fault-state fall property (e.g., direction, extent, etc.) of the mobile robot 630 may be dependent on respective fault-state behaviors of both the given actuator 670 and another one of the actuators 670. Relatedly, the method 620 can include causing a fault-state braking of a given one of the actuators 670 to be greater than a fault-state braking of another one of the actuators 670, such as by increasing the fault-state braking of the given one of the actuators 670 and decreasing the fault-state braking of the other one of the actuators 670.

Without reference to a particular embodiment, a difference in fault-state braking between actuators corresponding to joints at different respective legs of a mobile robot can change a fault-state fall property of the mobile robot. As an example in the context FIGS. 1 and 19, the legs 112a, 112b can correspond to the legs 634a, 634b, respectively. In this example, causing a fault-state braking of an actuator 670 corresponding to the joint 636a to be greater than a fault-state braking of an actuator 670 corresponding to the joint 636c can at least partially cause a fault-state fall direction of the mobile robot 630 to be lateral and toward the leg 112b, 634b. Similarly, causing a fault-state braking of an actuator 670 corresponding to the joint 636c to be greater than a fault-state braking of an actuator 670 corresponding to the joint 636a can at least partially cause a fault-state fall direction of the mobile robot 100, 630 to be lateral and toward the leg 112a, 634a. The same relationship can apply to the fault-state braking of actuators 670 corresponding to the joints 636b, 636d, respectively. Furthermore, the same relationship can apply to a combined fault-state braking of actuators 670 corresponding to all joints along a kinematic chain corresponding to the leg 112a, 634a relative to a combined fault-state braking of actuators 670 corresponding to all joints along a kinematic chain corresponding to the leg 112b, 634b.

Again without reference to a particular embodiment, in addition to or instead of an inter-leg difference, an intra-leg difference in fault-state braking between actuators corresponding to different respective joints at the same leg of a mobile robot can change a fault-state fall property of the mobile robot. As an example again in the context FIGS. 1 and 19, the legs 112a, 112b can again correspond to the legs 634a, 634b, respectively. The joints 636a, 636c can be kinematically proximal to the joints 636b, 636d, respectively. Furthermore, the joints 636a, 636c can correspond to joints (not labeled) at hip portions of the legs 112a, 634a, 112b, 634b, respectively. Still further, the joints 636b, 636d can correspond to joints (not labeled) at knee portions of the legs 112a, 634a, 112b, 634b, respectively. Counterintuitively, it can be useful for the fault-state braking of actuators 670 corresponding to the joints 636a, 636c to be lower than the fault-state braking of actuators 670 corresponding to the joints 636b, 636d. This can cause an anterior-to-posterior fault-state fall direction of the mobile robot 100, 630 to be more predictable than would otherwise be the case. For example, the torso 204 (FIG. 1) and body 632 (FIG. 19) can be intentionally tilted anteriorly at the joints 636a, 636c while operating the mobile robot 100, 630. When the mobile robot 100, 630 enters a fault state, anterior movement of the torso 204 and body 632 via rotation of the joints 636a, 636c can occur relatively quickly due to the intra-leg difference in fault-state braking. This movement, in turn, can cause the overall anterior-to-posterior fault-state fall direction of the mobile robot 100, 630 to be anterior. In a similar way, when the torso 204 and body 632 are intentionally tilted posteriorly at the joints 636a, 636c while operating the mobile robot 100, 630, the anterior-to-posterior fault-state fall direction of the mobile robot 100, 630 can reliably be posterior.

Inter-leg and intra-leg differences in fault-state braking can be combined to cause compound effects. Furthermore, when an intra-leg difference in fault-state braking is present and in other cases, it can nevertheless be useful for all of the relevant actuators 670 to have less than a maximum level of fault-state braking. Among other things, this can reduce the fault-state fall extent by causing the legs 112a, 634a, 112b, 634b to fold relatively quickly during a fault event. This, in turn, can cause downward motion of the torso 204 and body 632 onto the legs 112a, 634a, 112b, 634b to occur before outward motion of the torso 204 and body 632 over the legs 112a, 634a, 112b, 634b during the fault event. In at least some cases, causing the fault-state braking of actuators 670 corresponding to the joints 636a, 636c to be lower than the fault-state braking of actuators 670 corresponding to the joints 636b, 636d includes causing the actuators 670 corresponding to the joints 636b, 636d to have fault-state short circuiting of just a portion of the relevant windings 684. For example, this portion can be just the first-phase windings 686 or just a portion of the first-phase windings 686. In addition or alternatively, causing such a difference in fault-state braking can include causing the actuators 670 corresponding to the joints 636a, 636c to have fault-state short circuiting of a smaller portion of the relevant windings 684 or to have no fault-state short circuiting of the relevant windings 684.

The foregoing and/or other useful inter-leg and intra-leg differences in fault-state braking can also apply to operation of the mobile robots 640, 650, which are wheeled rather than legged. In at least some cases, the wheels 646, 658 have a default locked state that is triggered automatically in a fault event. For example, the mobile robots 640, 650 can include drive gearing (not shown) operably associated with the wheels 646, 658. The drive gearing can include spring-loaded latches biased toward a closed state. The drive gearing can also include catches that hold the spring-loaded latches open when powered and release the spring-loaded latches when unpowered. Thus, when power to the catches is lost during a fault event, the catches can release the spring-loaded latches, which can then engage and lock the wheels 646, 658. When the wheels 646, 658 are locked, inter-leg and intra-leg differences in fault-state braking can have effects similar to or the same as those discussed above for the mobile robots 100, 630. Moreover, in another example, a counterpart of the mobile robot 650 can include additional legs (not shown) arranged with the legs 654a, 654b around a vertical axis at a center of mass of the mobile robot 650. In this example, intra-leg differences in fault-state braking can cause the mobile robot 650 to have other suitable fault-state fall directions. For example, an intra-leg difference can be a gradient from least fault-state braking for an actuator 670 corresponding to a joint of a leg closest to a desired fault-state fall direction relative to the vertical axis, greater fault-state braking for actuators 670 corresponding to joints at circumferentially neighboring legs around the vertical axis, and even greater for actuators 670 corresponding to joints at circumferentially more distant legs around the vertical axis.

In the foregoing and in other examples, causing a difference in the respective fault-state behaviors of two actuators 670 can include causing back electromotive force braking of one actuator 670 in the absence of power from a battery to be active and back electromotive force braking of another actuator 670 in the absence of power from the battery to be inactive. Alternatively, causing a difference in the respective fault-state behaviors of two actuators 670 can include causing back electromotive force braking of both actuators 670 in the absence of power from the battery to be active, but at different respective levels. As discussed above, changing a level of back electromotive force braking of the actuator 670 in the absence of power from a battery can include causing a level of back electromotive force braking from the first-phase windings 686 in the absence of power from the battery to be different than a level of back electromotive force braking of the actuator 670 from the second-phase windings 688 in the absence of power from the battery. In at least some cases, this includes changing a fault-state behavior of the switch 692 to include short circuiting the first-phase windings 686 without short circuiting the second-phase windings 688. Similarly, changing a level of back electromotive force braking of the actuator 670 in the absence of power from a battery can include causing a level of back electromotive force braking from a given portion of the first-phase windings 686 in the absence of power from the battery to be different than a level of back electromotive force braking of the actuator 670 from another portion of the first-phase windings 686 in the absence of power from the battery. In at least some cases, this includes changing a fault-state behavior of the switch 692 to include short circuiting the given portion of the first-phase windings 686 without short circuiting the other portion of the first-phase windings 686.

With reference again to FIG. 14, changing the fault-state behavior of the actuator 670 can at least partially cause a fault-state fall direction of the mobile robot 630 to be away from a sensed human. Furthermore, the method 620 can include changing the fault-state fall direction of the mobile robot 630 in real time or in near real time to remain away from a sensed human as the location of the sensed human relative to the mobile robot 630 changes. In an example, the mobile robot 630 and a human may pass one another in an aisle while moving in opposite directions. During this interaction, a fault-state fall direction of the mobile robot 630 may begin as posterior and in a lateral direction away from an opposing lane of the aisle as the mobile robot 630 and the human approach one another. The fault-state fall direction of the mobile robot 630 may then progress to being in the same lateral direction, but anterior rather than posterior as the mobile robot 630 and the human pass one another.

During ordinary operation of the mobile robot 630, changing the fault-state behavior of the actuator(s) 670 may have little or no effect on movement of the mobile robot 630 because the mobile robot 630 does not enter a fault state. For example, during the passing interaction discussed above, the change in fault-state fall direction of the mobile robot 630 may be imperceptible absent intentional communication, such as that discussed above in the context of FIGS. 12 and 13. In some cases, however, the method 620 includes implementing a fault-state behavior of the actuator(s) 670. This can be at least partially in response to the mobile robot 630 entering a fault state. In an example, the method 620 includes sensing a breach of a boundary around the mobile robot 630 by a human. Entering the fault state can be at least partially in response to sensing the breach. As discussed above, other fault states are also possible. Furthermore, in the context of the mobile robot 630, implementing a fault-state behavior of the actuator(s) 670 can occur while the mobile robot 630 ambulates via the legs 634a, 634b. In the context of the mobile robot 640, implementing a fault-state behavior of the actuator(s) 670 can occur while the wheel 646 is in contact with a ground surface. Similarly, in the context of the mobile robot 650, implementing a fault-state behavior of the actuator(s) 670 can occur while the wheel 658 is in contact with a ground surface.

In at least some cases, implementing the fault-state behavior of the actuator(s) 670 is via the controller 676. The fault state, however, can include loss of power to the controller 676 and/or to the relevant actuator(s) 670 from a battery of the mobile robot 630. The method 620 can include collecting electricity from back electromotive force of the actuator(s) 670 and providing this electricity to the controller 676. In some cases this occurs at the actuator level. For example, the actuator 670 can include a capacitor (not shown) configured to collect electricity from back electromotive force of the actuator 670 and to provide the electricity to the controller 676 at the actuator 670. In other cases, electricity from back electromotive force from one actuator 670 can be used to implement a fault-state behavior of another actuator 670. In still other cases, the capacitor can carry electricity independent of back electromotive force. For example, the capacitor can charge from operating electricity of the actuator 670 before a fault state occurs. Furthermore, triggering implementation of a fault-state behavior can be at the actuator level or at a higher level. The implementation may occur automatically when the controller 676, e.g., using backup power from the capacitor, detects loss of power at the actuator 670. In addition or alternatively, the implementation may occur in response to higher-level communication within the mobile robot 630, such as failsafe fieldbus communication corresponding to entry of the mobile robot 630 into a fault state.

As mentioned above, FIGS. 15-18 are block diagrams corresponding to additional respective methods 622, 624, 626, 628 in accordance with at least some embodiments of the present technology. Selected features of the methods 622, 624, 626, 628 will now be described. As also mentioned above, when suitable, features described herein of any operations within any one of the methods 200, 500, 620, 622, 624, 626, 628 are also applicable to the same or similar operations in any other one of the methods 200, 500, 620, 622, 624, 626, 628. With reference now to FIGS. 1, 15 and 19-22 together, the method 622 can include operating the mobile robot 630 in an environment while the mobile robot 630 is in a first operating state (block 623a). The first operating state can be one in which the mobile robot 630 is dynamically stable. In the context of the mobile robot 640, the first operating state can be one in which the wheel 646 is in contact with a ground surface. Similarly, in the context of the mobile robot 650, the first operating state can be one in which the wheel 658 is in contact with a ground surface. Furthermore, operating the mobile robot 630 in the first operating state can occur while the mobile robot 630 ambulates via the legs 634a, 634b and/or while the actuator 670 draws power from a battery.

In at least some cases, while operating the mobile robot 630 in the first operating state, a fault-state braking of an actuator 670 operably associated with the leg 634a (e.g., configured to cause rotation at the joint 636a or at the joint 636b) is greater than a fault-state braking of a corresponding actuator 670 operably associated with the leg 634b (e.g., configured to cause rotation at the joint 636c or at the joint 636d). Correspondingly, a fault-state fall direction of the mobile robot 630 while the mobile robot 630 operates in the first operating state can be lateral relative to the body 632 and toward the leg 634b. The method 622 can further include changing the mobile robot 630 to a second operating state (block 623b) after operating the mobile robot 630 in the first operating state. Changing the mobile robot 630 to the second operating state can include changing the mobile robot 630 from the first operating state to the second operating state directly or indirectly, such as via one or more intermediate operating states. The method 622 can also include operating the mobile robot 630 in the second operating state (block 623c) after changing the mobile robot 630 to the second operating state. Like the first operating state, the second operating state can be one in which the mobile robot 630 is dynamically stable. In the context of the mobile robot 640, the second operating state can be one in which the wheel 646 is in contact with a ground surface. Similarly, in the context of the mobile robot 650, the second operating state can be one in which the wheel 658 is in contact with a ground surface. Furthermore, operating the mobile robot 630 in the second operating state can occur while the mobile robot 630 ambulates via the legs 634a, 634b and/or while the actuator 670 draws power from a battery.

Changing the mobile robot 630 to the second operating state can include changing a fault-state braking of the actuator 670, such as changing a fault-state back electromotive force braking of the actuator 670 in the absence of power from a corresponding battery. Changing the fault-state braking of the actuator 670 can include changing a ratio of back electromotive force braking of the actuator 670 from the first-phase windings 686 in the absence of power from the battery to back electromotive force braking of the actuator 670 from the second-phase windings 688 in the absence of power from the battery. Moreover, changing the fault-state braking of the actuator 670 can include changing a ratio of back electromotive force braking of the actuator 670 from a first portion of the first-phase windings 686 in the absence of power from the battery to back electromotive force braking of the actuator 670 from a different, second portion of the first-phase windings 686 in the absence of power from the battery. Furthermore, changing the fault-state braking of the actuator 670 can include changing a fault-state behavior of the switch 692, such as to cause fault-state short circuiting of the first-phase windings 686 without short circuiting the second-phase windings 688, to cause fault-state short circuiting of a first portion of the first-phase windings 686 without short circuiting a different, second portion of the first-phase windings 686, etc. In another example, when the actuator 670 includes first, second, and third switches configured to cause fault-state short circuiting of the first-phase windings 686, the second-phase windings 688, and the third-phase windings 690, respectively, changing the mobile robot 630 to the second operating state can include changing a ratio of a quantity of the these switches with fault-state on behavior to a quantity of these switches with fault-state off behavior.

The mobile robot 230 can have different respective fault-state behaviors (e.g., fault-state fall directions) while operating in the first and second operating states. For example, fault-state fall directions of the mobile robot 230 in the first and second operating states, respectively, can be opposite respective lateral directions relative to the body 632. As another example, fault-state fall directions of the mobile robot 230 in the first and second operating states, respectively, can be anterior and posterior relative to the body 632. While operating the mobile robot 630 in the second operating state, a fault-state braking of an actuator 670 operably associated with the leg 634b (e.g., configured to cause rotation at the joint 636c or at the joint 636d) can be greater than a fault-state braking of a corresponding actuator 670 operably associated with the leg 634a (e.g., configured to cause rotation at the joint 636a or at the joint 636b). Correspondingly, a fault-state fall direction of the mobile robot 630 while the mobile robot 630 operates in the second operating state can be lateral relative to the body 632 and toward the leg 634a. In an example, operating the mobile robot 630 in the first and second operating states occurs while the mobile robot 630 travels along an aisle in opposite respective directions. In addition or alternatively, operating the mobile robot 630 in the first and second operating states can occur while the mobile robot 630 has different respective levels and/or types of encumbrance. For example, operating the mobile robot 630 in the first and second operating states can occur while the mobile robot 630 is and is not carrying a payload, respectively. In these and other cases, the method 622 can include visually indicating an applicable fault-state behavior (e.g., fault-state fall direction) of the mobile robot 630 while the mobile robot 630 operates in the first and second operating states, respectively. This can occur via the same or different indicators of the mobile robot 630.

Finally, the method 622 can include implementing a fault-state behavior corresponding to the second operating state. In at least some cases, this occurs immediately after operating the mobile robot 630 in the second operating state. As discussed above in the context of the method 620, implementing a fault-state behavior corresponding to the second operating state can be at least partially in response to the mobile robot 630 entering a fault state. In an example, the method 622 includes sensing a breach of a boundary around the mobile robot 630 by a human. Entering the fault state can be at least partially in response to sensing the breach. In the context of the mobile robot 630, implementing a fault-state behavior corresponding to the second operating state can occur while the mobile robot 630 ambulates via the legs 634a, 634b. In the context of the mobile robot 640, implementing a fault-state behavior corresponding to the second operating state can occur while the wheel 646 is in contact with a ground surface. Similarly, in the context of the mobile robot 650, implementing a fault-state behavior corresponding to the second operating state can occur while the wheel 658 is in contact with a ground surface.

With reference now to FIGS. 1, 16 and 19-22 together, the method 624 can also include operating the mobile robot 630 in an environment (block 625a). In at least some cases, this occurs while the mobile robot 630 is dynamically stable. Furthermore, operating the mobile robot 630 can occur while the leg 634a at least partially supports the body 632. Still further, operating the mobile robot 630 can occur while the joint 636b is distal to the joint 636a along a kinematic chain defined by the leg 634a. Furthermore, the mobile robot 630 can include an elongate link extending between the joints 636a, 636b. In an example, the mobile robot 630 is humanoid in form. Relatedly, the elongate link can be a thigh link. Also relatedly, the joints 636a, 636b can be hip and knee joints, respectively. The method 624 can further include implementing fault-state behaviors of actuators 670 operably associated with the joints 636a, 636b, respectively. This can be at least partially in response to the mobile robot 630 entering a fault state. Moreover, implementing the fault-state behaviors of the actuators 670 operably associated with the joints 636a, 636b, respectively, can be at least partially in response to a power failure of the mobile robot 630, a communication failure of the mobile robot 630, or both.

In at least some cases, implementing the fault-state behaviors of the actuators 670 operably associated with the joints 636a, 636b, respectively, includes causing fault-state braking of the actuator 670 operably associated with the joint 636a to be at a given level while the actuator 670 operably associated with the joint 636b is unbraked or subject to a lower level of fault-state braking. Correspondingly, causing fault-state braking of the actuator 670 operably associated with the joint 636a can include causing a first level of back electromotive force braking of this actuator 670 in the absence of power from a battery while the actuator 670 operably associated with the joint 636b is unbraked or subject to a second level of back electromotive force braking in the absence of power from the battery lower than the first level of back electromotive force braking. Implementing the fault-state behaviors of the actuators 670 operably associated with the joints 636a, 636b, respectively, in the method 624 can have any of the advantages or other features discussed above in connection with an intra-leg difference in fault-state braking in the method 620. For example, implementing the fault-state behaviors of the actuators 670 operably associated with the joints 636a, 636b, respectively, can cause an anterior-to-posterior fault-state fall direction of the mobile robot 630 to be more predictable than would otherwise be the case.

With reference now to FIGS. 1, 17 and 19-22 together, the method 626 can include ambulating the mobile robot 630 in an environment (block 627a). In at least some cases, this includes ambulating the mobile robot 630 via a gait, such as a bipedal gait. The method 626 can further include changing fault-state braking of one or more actuators 670 operably associated with the joints 636a-636d, respectively, in concert with the gait. This approach can at least partially compensate for an influence of the gait on a fault-state fall property (e.g., fault-state fall direction) of the mobile robot 630 while ambulating the mobile robot 630. Furthermore, this approach can increase a consistency of a fault-state fall property (e.g., fault-state fall direction) of the mobile robot 630 while ambulating the mobile robot 630. In an example, changing fault-state braking of one or more actuators 670 operably associated with the joints 636a-636d, respectively, in concert with the gait causes a fault-state fall direction of the mobile robot 100, 630 to remain in a first lateral direction relative to the body 632 rather than to alternate between the first lateral direction and an opposite second lateral direction.

In a further example, the method 626 can include changing fault-state braking of an actuator 670 operably associated with the leg 634a (e.g., with the joint 636a or with the joint 636b) asynchronously relative to fault-state braking of an actuator 670 operably associated with the leg 634b (e.g., with the joint 636c or with the joint 636d) during the gait. In these and other cases, the method 626 can include causing the fault-state braking of an actuator 670 operably associated with the leg 634a (e.g., with the joint 636a or with the joint 636b) to be higher at a time during the gait when a foot carried by the leg 634a is planted on a ground surface and lower at a time during the gait when the foot is not planted on the ground surface. Likewise, the method 626 can include causing the fault-state braking of an actuator 670 operably associated with the leg 634b (e.g., with the joint 636c or with the joint 636d) to be higher at a time during the gait when a foot carried by the leg 634b is planted on a ground surface and lower at a second time during the gait when the foot is not planted on the ground surface. The mobile robot 630 can determine when the foot carried by the leg 634a is in contact with the ground surface via feedback from a contact sensor at this foot or in another suitable manner. Similarly, the mobile robot 630 can determine when the foot carried by the leg 634b is in contact with the ground surface via feedback from a contact sensor at this foot or in another suitable manner.

The fault-state fall property control system may also incorporate adaptive learning mechanisms that refine safety parameters based on operational experience and environmental feedback. In some embodiments, a computer system operably associated with the mobile robot 630 implements reinforcement learning algorithms that monitor the effectiveness of different fault-state fall property configurations across various operational scenarios, gradually optimizing the balance between safety constraints and operational efficiency. The system may track metrics such as the frequency of safety interventions, the smoothness of motion command transitions, and the proximity of actual fault-state fall properties to their respective limits during normal operation. Machine learning models may analyze patterns in these metrics to identify opportunities for improving fault-state fall property management, such as recognizing that certain environmental conditions consistently require more conservative fall direction constraints or that specific payload configurations benefit from adjusted fall extent limits. The adaptive learning system may also incorporate feedback from human operators or safety personnel, allowing the mobile robot 630 to learn from near-miss incidents or operational inefficiencies reported by users. Furthermore, the system may implement collaborative learning capabilities, where multiple robots operating in similar environments can share their learned safety parameter optimizations, enabling fleet-wide improvements in fault-state fall property control strategies. This collective intelligence approach may accelerate the refinement of safety protocols across diverse operational contexts.

More advanced coordination between the gait and fault-state braking of actuators 670 operably associated with the legs 634a, 634b, respectively, is also possible. For example, the computer system operably associated with the mobile robot 630 can include a machine learning model configured to output settings for the actuators 670 (e.g., for the switches 692 or for other switches operably associated with the first-phase windings 686, the second-phase windings 688, the third-phase windings 690, portions thereof, respectively, etc.) based on one or more variables relating to a gait of the mobile robot 630. The model may be a reinforcement learning model trained using a function that rewards desirable fault-state behavior of the mobile robot 630 and penalizes undesirable fault-state behavior of the mobile robot 630. For example, the desirable fault-state behavior of the mobile robot 630 may be a leftward fault-state fall direction, a rightward fault-state fall direction, an anterior fault-state fall direction, a posterior fault-state fall direction, etc. The mobile robot 630 can provide the model with kinematic data (e.g., whole-body kinematic data) and/or other data in real time, in near real time, or in advance of implementation and receive settings for one or more actuators 670 of the mobile robot 630 that cause (e.g., collectively cause) a desired fault-state behavior of the mobile robot 630. The mobile robot 630 can then implement these settings.

With reference now to FIGS. 1 and 18-22 together, the method 628 can again include operating the mobile robot 630 in an environment (block 629a). In an example, the mobile robot 630 defines a midsagittal plane during this operation. Furthermore, the legs 634a, 634b can be at opposite respective sides of the midsagittal plane during this operation. The method 628 can further include ambulating the mobile robot 630 in a first direction along an aisle of the environment (block 629b). In at least some cases, the ambulating is bipedal. The ambulating can occur while the mobile robot 630 is in a first longitudinal region of the aisle. The aisle can also include a second longitudinal region. The first and second longitudinal regions of the aisle can be at opposite respective sides of a plane bisecting the aisle lengthwise. While ambulating the mobile robot 630, a difference between fault-state behaviors of actuators 670 operably associated with the legs 634a, 634b, respectively, can at least partially cause a fault-state fall direction of the mobile robot 630 to be away from the second longitudinal region of the aisle. In at least some cases, this persists throughout a full gait cycle of the mobile robot 630.

The difference between the fault-state behaviors of the actuators 670 operably associated with the legs 634a, 634b, respectively, can be a difference in respective fault-state braking of these actuators 670. Furthermore, while ambulating the mobile robot 630, the actuators 670 operably associated with the legs 634a, 634b, respectively, can draw power from a battery of the mobile robot 630. In these and other cases, the difference in the fault-state braking of the actuators 670 operably associated with the legs 634a, 634b, respectively, can be a difference in respective back electromotive force braking of these actuators 670 in the absence of power from the battery. Furthermore, the difference in the fault-state behaviors of the actuators 670 operably associated with the legs 634a, 634b, respectively, can be a difference in respective fault-state short-circuiting of windings 684 of these actuators 670. For example, the difference can be a difference in respective fault-state short-circuiting of the first-phase windings 686, of the second-phase windings 688, of the third-phase windings 690, of portions thereof, etc. Finally, the method 624 can include implementing fault-state behaviors of the actuators 670 operably associated with the joints 636a, 636b, respectively (block 629c). This can be at least partially in response to the mobile robot 630 entering a fault state. Moreover, implementing the fault-state behaviors of the actuators 670 operably associated with the joints 636a, 636b, respectively, can be at least partially in response to a power failure of the mobile robot 630, a communication failure of the mobile robot 630, or both.

### Examples of Electrical, Computer, and Software Systems

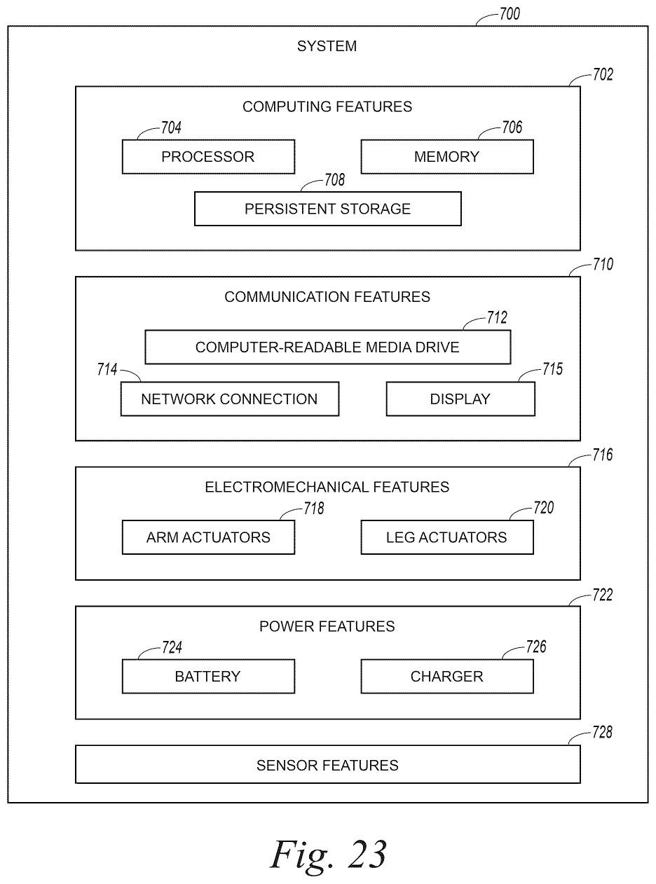

FIG. 23 is a block diagram depicting a system 700 including electrical, computer, and software features operably associated with a mobile robot in accordance with at least some embodiments of the present technology. The system 700 is described primarily in the context of the mobile robot 100 (FIG. 1) as an example. When suitable, operations described elsewhere in this disclosure can be implemented at least partially via the devices and systems disclosed in this section. For example, the computer system 254 (FIGS. 3 and 4) discussed above can be part of the system 700. Furthermore, the system 700 can be operably associated with any of the mobile robots 100, 600, 630, 640, 650 described herein. Still further, any suitable operations of the methods 200, 500, 620, 622, 624, 626, 628 described herein can be implemented at least partially via the system 700.

As shown in FIG. 23, the system 700 can include computing features 702. The computing features 702 can include a processor 704, such as one or more general-purpose or special-purpose integrated circuits including digital logic gates for executing programs or for otherwise processing data. The computing features 702 can further include memory 706, such as one or more integrated circuits for storing data in use. The memory 706 can include a multithreaded program, an operating system including a kernel, device drivers, etc. The computing features 702 can further include persistent storage 708, such as a hard drive for persistently storing data. Examples of data that can be stored by the persistent storage 708 include diagnostic data, sensor data, configuration data, environmental data, and current-state data. The computing features 702 can collectively define a computer configured to manage, control, receive information from, deliver information to, and/or otherwise usefully interact with other features of the system 700.

The system 700 can further include communication features 710. The communication features 710 can include a computer-readable media drive 712 for reading computer programs and/or other data stored on computer-readable media. As one example, the computer-readable media drive 712 can be a flash-memory drive. The communication features 710 can further include a network connection 714 for connecting the mobile robot 100 to other devices and systems, such as other mobile robots and/or other computer systems. The network connection 714 can be wired or wireless and can be via the Internet, a Local Area Network (LAN), a Wide Area Network (WAN), BLUETOOTH®, Wi-Fi®, a cellular-phone network, etc. The network connection 714 can include networking hardware, such as routers, switches, transmitters, receivers, computer-readable transmission media, etc. The communication features 710 can further include a display 715 (e.g., a touchscreen) and/or other suitable features for communicating with a user. The mobile robot 100 can use the communication features 710 for internal and/or external operations. Examples of these operations include interacting with systems that provide contextual information about the environment in which the mobile robot 100 operates and interacting with systems for changing operating conditions of the mobile robot 100.

The system 700 can further include electromechanical features 716. The electromechanical features 716 can include arm actuators 718 and leg actuators 720 operably associated with respective joints of the arms 110a, 110b and the legs 112a, 112b. In addition or alternatively, the electromechanical features 716 can include other suitable features for implementing mechanical action within the mobile robot 100. As shown in FIG. 23, the system 700 can further include power features 722, such as a battery 724 and a charger 726. The battery 724 can be a lithium-ion battery, a sodium-ion battery, or a battery of another suitable type. The charger 726 can include a connector (not shown) compatible with a power source (e.g., a wall outlet, a charging station, etc.) and leads extending between the connector and the battery 724. In at least some cases, the mobile robot 100 is configured to operate wirelessly via the battery 724 and to recharge via the charger 726. Where suitable, actuators and batteries in discussions of various embodiments of the present technology herein can be included among the electromechanical features 716.

Finally, the system 700 can include sensor features 728 for capturing, providing, and/or analyzing information about the mobile robot 100 itself and/or the environment in which the mobile robot 100 operates. The sensor features 728 can include a vision sensor (e.g., a camera), a light sensor (e.g., a photoresistor), a sound sensor (e.g., a microphone), a location sensor (e.g., a Global Positioning System (GPS) sensor), a two-dimensional sensor, a three-dimensional sensor, and/or a proximity sensor, among other examples. Within the body 102 and/or at one or more other suitable locations, the mobile robot 100 can include among the sensor features 728, an accelerometer, a gyroscope, a magnetometer, and/or a tilt sensor, among other examples. At the end effectors 114a, 114b, at the feet 116a, 116b, and/or at one or more other suitable locations, the mobile robot 100 can include among the sensor features 728, a contact sensor and/or a force sensor. In at least some cases, two or more different types of sensors are incorporated into a sensor assembly of the mobile robot 100. For example, an accelerometer, a gyroscope, and a magnetometer or another suitable combination of sensors can be incorporated into an inertial measurement unit (IMU) through which the mobile robot 100 can determine parameters such as acceleration, angular velocity, and orientation. The mobile robot 100 can include an IMU within the torso 104, within the head 106, and/or at one or more other suitable locations.

At one, some, or all of the arm actuators 718, at one, some, or all of the leg actuators 720, and/or at one or more other suitable locations, the mobile robot 100 can include among the sensor features 728, sensors that measure properties of corresponding joints. Such properties can include position, orientation (e.g., yaw, pitch, and roll), applied force (e.g., torque), elevation, mass, velocity, and acceleration, among other examples. The measurements of these properties can be direct or indirect. As an example of direct sensing, the mobile robot 100 may sense a torque acting on a given joint via a torque sensor operably associated with the joint, such as a torque sensor that outputs torque as function of current. As another example of direct sensing, the mobile robot 100 may sense a position of a given joint via an encoder operably associated with the joint. Any joint described herein should be construed as potentially including a torque sensor, encoder, and/or other suitable mechanism for direct sensing. As an example of indirect sensing, the mobile robot 100 may sense a position of a given one of the end effectors 114a, 114b or other feature based on perception data corresponding to the feature and other data corresponding to a reference. The mobile robot 100 can include one or more sensors in a sensor system, such as a vision system, a LiDAR system, a stereoscopic camera system, a SONAR system, etc. In at least some cases, the mobile robot 100 monitors itself and/or its environment in real-time or in near real time. Moreover, the mobile robot 100 may use acquired sensor data as a basis for decision-making via the computing features 702.

Features of the system 700 can be connected to one another and/or to other features of the mobile robot 100 via suitable conductors, transmitters, receivers, circuitry, etc. While the system 700 configured as described may be used to support operation of the mobile robot 100, it should be appreciated that the mobile robot 100 may be operated using devices of various types and configurations and that such devices may have various components and levels of responsibility. For example, the mobile robot 100 may employ individual computer systems and/or controllers to manage discrete aspects of its operations, such as an individual computer system or controller to perform computer vision operations, a separate computer system or controller to perform power management, etc. In some cases, the mobile robot 100 employs the system 700 to control physical aspects of the mobile robot 100 according to one or more designated rules encoded in software. For example, these rules can include minimums and/or maximums, such as a maximum degree of rotation for a joint, a maximum speed at which a link is allowed to move, a maximum acceleration rate for the feet 116a, 116b, etc. The mobile robot 100 may include any number of mechanical aspects and associated rules, which may be based on or otherwise configured in accordance with the purpose of and/or functions performed by the mobile robot 100.

Software features of the system 700 and other computer systems described herein may take the form of computer-executable instructions, such as program modules executable by the computing features 702. Generally, program modules include routines, programs, objects, data structures, or the like configured to perform particular tasks based on source data, which may be encrypted. Control scripts may be implemented via a suitable language, such as C/C++ or Python®. The functionality of the program modules may be combined or distributed in various embodiments, including in cloud-based implementations. Furthermore, certain aspects of the present technology can be embodied in special purpose computers or data processors, such as in application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a LAN, a WAN, or the Internet. In a distributed computing environment, program modules and other features may be located in both local and remote memory storage and in other devices, which may be in communication via one or more wired or wireless communication channels.

Aspects of the present technology may be stored or distributed on tangible computer-readable media, which can include volatile or non-volatile storage features, such as magnetically or optically readable computer media, hard-wired or preprogrammed chips (e.g., electrically erasable programmable read-only memory semiconductor chips), nanotechnology memory, or other computer-readable storage media. Alternatively, computer-implemented instructions, data structures, screen displays, and other data under aspects of the present technology may be distributed (encrypted or otherwise) over the Internet or over other networks (including wireless networks) on a propagated signal on a propagation medium (e.g., electromagnetic wave(s), sound wave(s), etc.) over a period of time. Furthermore, such data may be provided on an analog or digital network and packet switched, circuit switched, or managed under another suitable scheme. The term computer-readable storage medium as used herein does not, however, encompass signals themselves (e.g., propagating signals) or transitory media. One of ordinary skill in the art will recognize that various features of the mobile robot 100 and other devices and systems described herein may communicate via any number of wired or wireless communication techniques and that elements of such devices and systems may be distributed rather than located in a single monolithic entity. Finally, electrical and computing aspects of systems in accordance with various embodiments of the present technology may operate in environments or according to processes other than the examples of environments and processes described herein.

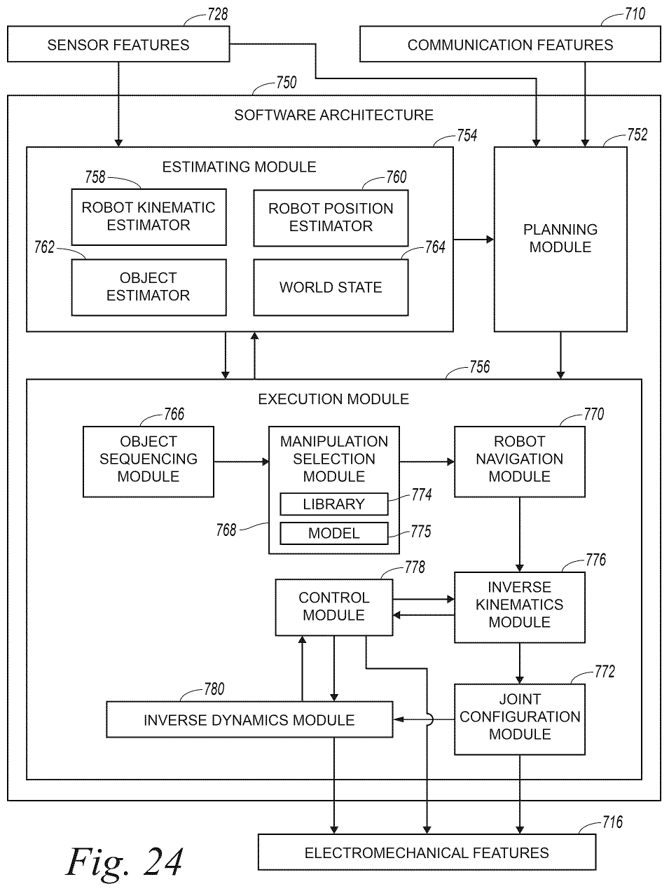

FIG. 24 is a block diagram depicting software architecture 750 and associated portions of the system 700. The software architecture 750 can be within the memory 706 or otherwise operably associated with any or all of the various features of the system 700 as described above. With reference to FIGS. 23 and 24 together, the software architecture 750 can include a planning module 752, an estimating module 754, and an execution module 756 operably associated with one other. The planning module 752 can be configured to relay or to generate a plan corresponding to an objective for the mobile robot 100 (e.g., unload all objects on a shelf, retrieve an object from a first location and move the object to a second location, etc.). In at least some cases, the planning module 752 receives information from the communication features 710 of the system 700 and relays or generates a plan based at least partially on the received information. For example, the planning module 752 may receive a task request from a user via the communication features 710 and relay the task request as a plan. As another example, the planning module 752 may receive a task request from a user via the communication features 710 and generate a plan related to the task request. As yet another example, the planning module 752 may generate a plan without receiving a task request from a user, such as at a predetermined time and/or in response to information about a current state of the mobile robot 100 or the environment received via the sensor features 728 of the system 700. Software components of the computer system 254 (FIGS. 3 and 4) discussed above in connection with the methods 200, 500 can be implemented in the software architecture 750 via the planning module 752.

The estimating module 754 can receive information from the sensor features 728 and generate estimates in real time or in near real time to inform generating and/or executing a plan. The estimating module 754 can include a robot kinematic estimator 758, a robot position estimator 760, an object estimator 762, and a world state 764. The robot kinematic estimator 758 can generate an estimate of a current kinematic state of the mobile robot 100 (e.g., balanced, off-balance, walking, standing, etc.) and estimates of positions of individual joints of the mobile robot 100. The robot position estimator 760 can generate a current estimate of a position of the mobile robot 100 within an environment. This position can be a set of coordinates and can be based on perception information, GPS information, and/or other information received by or generated by the mobile robot 100. Perception information potentially relevant to the position of the mobile robot 100 includes, among other examples, information corresponding to distances between the mobile robot 100 and landmarks in an environment and information corresponding to fiducial markings (e.g., AprilTags) carried by or otherwise associated with the landmarks. This information can be detected, for example, via a camera of the mobile robot 100. Furthermore, information can move between components of the estimating module 754. For example, the world state 764 can receive information from the robot kinematic estimator 758, the robot position estimator 760, and the object estimator 762. In addition or alternatively, the object estimator 762 can receive information from the robot kinematic estimator 758 and the robot position estimator 760.

The object estimator 762 can generate a current estimate of an object within an environment. In at least some cases, the estimate is a pose or other reference corresponding to a position and orientation of the object. As with the position of the mobile robot 100 itself, the position of an object can be a set of coordinates and can be based on perception information, GPS information, and/or other information received by or generated by the mobile robot 100. Perception information potentially relevant to the position of an object includes, among other examples, information corresponding to distances between the object and the mobile robot 100, distances between the object and landmarks in an environment, and information corresponding to fiducial markings (e.g., AprilTags) carried by or otherwise associated with the object. This information can be detected, for example, via a camera of the mobile robot 100. In at least some cases, the object estimator 762 uses information (e.g., sensor poses) from the robot kinematic estimator 758 and/or the robot position estimator 760 to inform generation of object estimates. This can be useful, for example, when a fiducial or other landmark in an environment is not visible. The object estimator 762 can be configured to update the world state 764 with object references and/or other information related to objects in an environment in which the mobile robot 100 operates. Furthermore, the object estimate can include an identification of an object and properties (e.g., dimensions) associated with that identification. For example, the object estimator 762 can include an object-recognition model (e.g., Detectron2 (Facebook AI Research) with Mask R-CNN implementation) that receives perception information (e.g., an image) corresponding to an object and outputs an object identification based at least partially on the perception information. The object estimator 762 can further include a lookup table for generating object properties based at least partially on this object identification.

The execution module 756 can be configured to receive a plan from the planning module 752 and estimates from the estimating module 754. The plan can include one or more motion commands and/or motion-command precursors as discussed above in connection with examples of the methods 200, 500. The execution module 756 can include an object sequencing module 766, a manipulation selection module 768, a robot navigation module 770, and a joint configuration module 772. The planning module 752 can be configured to send a plan to the object sequencing module 766, to the manipulation selection module 768, to the robot navigation module 770, or to the joint configuration module 772 based on attributes of the plan. For example, when a plan includes explicit instructions for positions of the electromechanical features 716 of the system 700, the planning module 752 can send the plan to the execution module 756 via the joint configuration module 772. As another example, when a plan does not involve manipulating an object, the planning module 752 can send the plan to the execution module 756 via the robot navigation module 770. As yet another example, when a plan concerns only one object and the object is remote to the mobile robot 100, the planning module 752 can send the plan to the execution module 756 via the manipulation selection module 768. As a final example, when a plan concerns multiple objects remote to the mobile robot 100, the planning module 752 can send the plan to the execution module 756 via the object sequencing module 766.

The object sequencing module 766 can receive one or more estimates from the estimating module 754 and can generate a sequence in which multiple objects are to be manipulated. For example, when the object sequencing module 766 receives a plan to unload a shelf, the object sequencing module 766 can query the estimating module 754 for current locations of objects on the shelf. The object sequencing module 766 can then assign the objects an order, convert the order into a queue, and pass the queue to the manipulation selection module 768. The manipulation selection module 768 can include a library 774 including manipulation primitives and/or sequences of manipulation primitives that can be used to manipulate an object. The manipulation selection module 768 can select manipulation primitives and/or sequences for a given object based on contextual information, such as information about the object and/or information about the environment. In addition or alternatively, the manipulation selection module can include a model 775 that outputs manipulation estimates based on contextual information. The robot navigation module 770 can generate targets for different parts of the mobile robot 100 further to a manipulation portion or other portions of a plan being executed. Examples of targets include positions of the feet 116a, 116b in the environment, positions of the end effectors 114a, 114b in the environment, etc. The robot navigation module 770 can update these targets continuously or near continuously based on information from the estimating module 754. The execution module 756 can further include an inverse kinematics module 776 that translates the targets from the robot navigation module 770 into joint configurations throughout the mobile robot 100.

The execution module 756 can also include a control module 778 that receives joint configurations from the inverse kinematics module 776 and generates joint parameters (e.g., positions, velocities, accelerations, etc.) to be executed by the mobile robot 100 via the electromechanical features 716 of the system 700 to achieve these joint configurations. Through continuous or near-continuous communication with the inverse kinematics module 776, the control module 778 can modify the joint parameters to at least partially compensate for deviations as the mobile robot 100 executes the joint configurations. The inverse kinematics module 776 can send other joint configurations not subject to active control to the joint configuration module 772 directly. Similar to the control module 778, the joint configuration module 772 can generate joint parameters (e.g., positions, velocities, accelerations, etc.) to be executed by the mobile robot 100 to achieve joint configurations received from the inverse kinematics module 776 or from the planning module 752.

Finally, the execution module 756 can include an inverse dynamics module 780 that receives joint parameters from the control module 778 and from the joint configuration module 772. The inverse dynamics module 780 can track a desired wrench of the mobile robot 100 and its relationship with objects in the environment. In at least some cases, the inverse dynamics module 780 references a map of robot positions and wrenches to joint torques. Based at least partially on tracking these joint torques, the inverse dynamics module 780 can modify joint parameters to achieve a desired result. For example, the inverse dynamics module 780 may modify joint parameters from the control module 778 and from the joint configuration module 772 to maintain contact between the end effectors 114a, 114b and an object as the mobile robot 100 carries the object. The inverse dynamics module 780 can then send modified joint parameters to the electromechanical features 716 of the system 700 for execution. For configurations that do not involve dynamic interaction with the environment, the control module 778 and the joint configuration module 772 can send joint parameters directly to the electromechanical features 716 for execution.

With reference to FIGS. 23 and 24 together, suitable software components disclosed herein can be part of a distributed system or component thereof or implemented as one or more network-based services. For example, a compute cluster within a computing service may present computing or storage services or other types of services that employ any distributed computing systems described herein to clients as network-based services. In some embodiments, a network-based service may be implemented by a software or hardware system designed to support interoperable machine-to-machine interaction over a network. A network-based service may have a gateway described in a machine-processable format. Other systems may interact with the network-based service in a manner prescribed by the description of the network-based service's gateway. For example, the network-based service may define various operations that other systems may invoke. Relatedly, the network-based service may define a particular API to which other systems may be expected to conform when requesting the various operations. In the cloud provider network context, APIs may provide a gateway for customers to access cloud infrastructure by allowing customers to obtain data from and/or to cause actions within the cloud provider network, enabling the development of applications that interact with resources and services hosted in the cloud provider network. APIs can also enable different services of the cloud provider network to exchange data with one another.

In a distributed system, some or all of the software architecture 750 and other software described herein can be executed remotely from the mobile robot 100. For example, the mobile robot 100 can be configured to collect raw sensor data via the sensor features 728 of the system 700 and to transmit some or all of this raw sensor data to a remote server in real time or near real time for processing. The mobile robot 100 can then receive joint commands and/or other products of this processing via communication with the server. In these and other cases, computing operations can be allocated among local and remote computing systems depending on factors such as computing demand, available computing resources, time sensitivity of computing products, etc. Moreover, even the sensor features 728 can be remote from the mobile robot 100 in certain cases. For example, a remote sensor may track its reference frame relative to a local sensor of the mobile robot 100 and may communicate that reference frame with sensor data it collects at any given time. A server receiving the sensor data can then use the relationship between the reference frame of the local sensor and the reference frame of the remote sensor to generate output in a reference frame compatible with processes that rely on sensor data from the local sensor only. Alternatively, in a non-distributed system, all information processing and command execution can occur locally at the mobile robot 100 or other local hardware depending on the implementation.

### CONCLUSION

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Any reference herein to “the inventors” means at least one inventor of the present technology. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, generating, and selecting information in accordance with various embodiments of the present technology encompass, when feasible, the others of receiving, determining, generating, and selecting the information and indicate that such operations can occur at least partially via the relevant computing subsystem.

In the context of fault-state fall properties, when reference is made to “a fault-state fall direction,” this encompasses embodiments having multiple fault-state fall directions that may be monitored and controlled simultaneously or sequentially. Similarly, “an actuator” includes implementations with multiple actuators working in coordination to achieve desired behaviors. As used herein, the terms “real-time” or and “near real-time” are broad terms that encompass processing, calculating, determining, monitoring, or performing other operations with various degrees of latency that are sufficiently prompt for the intended application. For example, “real-time” processing may include operations performed with minimal latency appropriate for the specific application context, which may range from microseconds to seconds depending on the operational requirements, computational resources available, and safety criticality of the task being performed. “Near real-time” processing may include operations with somewhat greater latency than “real-time”processing but still sufficiently responsive for the intended application.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

1. A method comprising:
generating, via a computer system operably associated with a mobile robot, a first motion command for changing a pose of the mobile robot;
determining, via the computer system, an indication of a fault-state fall property of the mobile robot corresponding to the first motion command;
generating, via the computer system, a second motion command for changing the pose of the mobile robot based at least partially on the indication; and
executing, via an actuator of the mobile robot, movement of the mobile robot corresponding to the second motion command.

2. The method of claim 1, wherein:
determining the indication includes determining the indication of a fault-state fall extent of the mobile robot; and
generating the second motion command includes generating the second motion command based at least partially on the indication of the fault-state fall extent of the mobile robot.

3. The method of claim 1, wherein:
determining the indication includes determining the indication of a fault-state fall direction of the mobile robot; and
generating the second motion command includes generating the second motion command based at least partially on the indication of the fault-state fall direction of the mobile robot.

4. The method of claim 3, wherein:
determining the indication includes determining the indication of the fault-state fall direction of the mobile robot being lateral and/or posterior relative to a torso of the mobile robot; and
generating the second motion command includes generating the second motion command based at least partially on the indication of the fault-state fall direction of the mobile robot being lateral and/or posterior relative to the torso.

5. The method of claim 3, wherein:
determining the indication includes determining the indication of the fault-state fall direction of the mobile robot approaching lateral and/or posterior relative to a torso of the mobile robot; and
generating the second motion command includes generating the second motion command based at least partially on the indication of the fault-state fall direction of the mobile robot approaching lateral and/or posterior relative to the torso.

6. The method of claim 1, wherein:
the method further comprises executing, via the same or a different actuator of the mobile robot, movement of the mobile robot corresponding to the first motion command; and
determining the indication includes determining the indication while or immediately after executing the movement of the mobile robot corresponding to the first motion command.

7. The method of claim 6, further comprising:
causing, by executing the movement of the mobile robot corresponding to the first motion command, the fault-state fall property of the mobile robot to move outside of a target range; and
causing, by executing the movement of the mobile robot corresponding to the second motion command, the fault-state fall property of the mobile robot to move into the target range.

8. The method of claim 1, further comprising:
generating, via the computer system, an override command at least partially in response to determining the indication; and
overriding, via the computer system, at least a portion of the first motion command at least partially in response to generating the override command.

9. (canceled)

10. The method of claim 1, wherein:
the method further comprises receiving, at the computer system, joint-encoder data from joint encoders of the mobile robot; and
determining the indication includes determining the indication based at least partially on the joint-encoder data.

11. (canceled)

12. The method of claim 1, wherein:
the method further comprises determining, via the computer system, a center-of-mass property of the mobile robot; and
determining the indication includes determining the indication based at least partially on the center-of-mass property.

13-14. (canceled)

15. The method of claim 12, wherein:
the method further comprises comparing the center-of-mass property to a condition; and
determining the indication includes determining the indication based at least partially on a result of comparing the center-of-mass property to the condition.

16. The method of claim 15, further comprising:
determining, via the computer system, respective poses of feet of the mobile robot; and
determining, via the computer system, the condition based at least partially on the respective poses of the feet.

17. The method of claim 16, wherein:
determining the condition includes determining the condition to include a fault-state fall direction component and a fault-state fall extent component; and
the method further comprises determining the fault-state fall direction component of the condition based at least partially on the respective poses of the feet.

18. The method of claim 16, wherein:
determining the respective poses of the feet includes determining the respective poses of the feet while a first one of the feet is in contact with a ground surface and a second one of the feet is out of contact with the ground surface;
the method further comprises generating, via the computer system, a projection of the second one of the feet onto the ground surface; and
determining the condition includes determining the condition based at least partially on the pose of the first one of the feet and the projection of the second one of the feet.

19. The method of claim 15, further comprising:
determining, via the computer system, a fulcrum plane of the mobile robot; and
determining, via the computer system, the condition based at least partially on the fulcrum plane.

20. The method of claim 15, further comprising:
determining, via the computer system, a support polygon of the mobile robot; and
determining, via the computer system, the condition based at least partially on the support polygon.

21. The method of claim 20, further comprising:
determining, via the computer system, a segment of the support polygon; and
determining, via the computer system, the condition based at least partially on the segment.

22. The method of claim 21, wherein:
determining the segment includes determining an anterior segment of the support polygon relative to a torso of the mobile robot; and
determining the condition includes determining the condition based at least partially on the anterior segment.

23. (canceled)

24. The method of claim 1, wherein:
the mobile robot includes:
a body, and
legs configured to support at least a portion of the body; and
executing the movement of the mobile robot includes executing the movement of the mobile robot while the mobile robot ambulates via the legs.

25. The method of claim 1, wherein:
the mobile robot includes:
a body, and
a wheel configured to support at least a portion of the body; and
executing the movement of the mobile robot includes executing the movement of the mobile robot while the wheel is in contact with a ground surface.

26-172. (canceled)
